(19) United States
(12) Patent Application Publication
(10) Pub. No.: US 2006/0017532 A1
(43) Pub. Date: Jan. 26, 2006

(54) Metallic contact electrical switch incorporating lorentz actuator

(76) Inventor: William R. Trutna JR., Atherton, CA (US)

Correspondence Address: AGILENT TECHNOLOGIES, INC.;INTELLECTUAL PROPERTY ADMINISTRATION, LEGAL DEPT., P.O. BOX 7599, M/S DL429, LOVELAND, CO, 80537-0599, US

(21) Appl. No.: 10/898,646

(22) Filed: Jul. 23, 2004

(51) Int. Cl. H01H 29/00

(52) U.S. Cl. 335/47

(57) ABSTRACT

The metallic contact switch comprises a housing defining a cavity, a conductive switching liquid in the cavity, switch contacts located in the cavity in electrical contact with the switching liquid in at least one switching state of the switch and a Lorentz actuator comprising conductive actuating liquid located in the cavity and capable of movement in the cavity. The Lorentz actuator is mechanically coupled to the switching liquid to change the switching state of the switch.

### BACKGROUND

Many electronic devices include one or more switches that control electronic signals, voltages or currents, which, to simplify the following description, will collectively be referred to as signals. In many cases, transistors are used to switch relatively low-power, low-frequency signals. However, in other cases, especially those in which the signal power is high and/or the signal frequency is high, or in cases in which great precision is needed, it is often desirable to switch a signal using metallic contacts, rather than using a transistor, because a transistor can alter, distort or degrade the signal, or may impose a limitation on the signal power, or may leak in its open state or may attenuate the signal in its closed state.

A reed relay is a typical example of a conventional miniature metallic contact switch. A reed relay has two reeds made of a magnetic alloy sealed together with an inert gas in a glass envelope. The envelope is surrounded by an electromagnetic driver coil. In the OFF state of the switch, no current flows through the driver coil and the reeds are biased to break contact between the tips of the reeds. In the ON state of the switch, current flowing through the coil causes the reeds to attract each other and to move into contact with each other. This establishes an electrical circuit between the reeds.

The reed relay has problems related to its relatively large size and relatively short service life. As to the first problem, the reeds and magnetic coil are physically large compared with a transistor, for example. Moreover, the large size and relatively slow electromagnetic response of the reeds impairs the performance of the reed relay when a high switching rate is required. As to the second problem, the flexing of the reeds as they switch causes mechanical fatigue, which can lead to breakage of the reeds after extended use.

In some applications, the reeds are tipped with contacts of rhodium (Rh) or tungsten (W), or are plated with rhodium (Rh) or gold (Au), to provide a high electrical conductivity and an ability to withstand electrical arcing during switching. However, contacts of these materials will typically fail over time. A type of reed relay called a “wet” relay has a longer service life than a conventional reed relay. In a wet relay, a liquid metal, such as mercury (Hg) provides the electrical contact between the reeds. This solves the problem of contact failure, but the problem of mechanical fatigue of the reeds remains unsolved.

Liquid metal switches have a thread of liquid metal in a channel and switch electrodes spaced apart along the length of the channel. A liquid metal switch is described in U.S. Pat. No. 6,323,447 of Kondoh et al., assigned to the assignee of this disclosure, and incorporated into this disclosure by reference. The liquid metal electrically connects the switch electrodes when the switch is in its ON state. An insulating fluid separates the liquid metal at a point between the switch electrodes when the switch is in its OFF state. The insulating fluid is typically high-purity nitrogen (N) or another such inert gas.

Liquid metal switches solve many of the problems of conventional reed relays. Liquid metal switches are substantially smaller than conventional reed relays. Also, the liquid metal switch has a longer service life and higher reliability. Finally, the liquid metal switches can be made using conventional wafer-scale fabrication methods and are therefore relatively inexpensive. However, liquid metal switches are actuated by heating the insulating fluid. This actuation method is relatively slow, can be difficult control and can have relatively high power consumption.

Thus, what is needed is a miniature metallic contact electrical switch that lacks the disadvantages of the conventional heat-actuated liquid metal switch.

### SUMMARY OF THE INVENTION

The invention provides a metallic contact switch that comprises a housing defining a cavity, a conductive switching liquid in the cavity, switch contacts located in the cavity in electrical contact with the switching liquid in at least one switching state of the switch and a Lorentz actuator comprising conductive actuating liquid located in the cavity and capable of movement in the cavity. The Lorentz actuator is mechanically coupled to the switching liquid to change the switching state of the switch.

The Lorentz actuator typically has a faster response time, consumes less power and is easier to control than the heated insulating fluid actuators referred to above.

### BRIEF DESCRIPTION OF THE DRAWINGS

FIG. 1 is an isometric view of a liquid metal pump that demonstrates the principles of a Lorentz actuator.

FIGS. 2A and 2B are respectively a plan view and a side elevation of a first embodiment of a metallic contact electrical switch in accordance with the invention.

FIG. 2C is a cut-away plan view of the embodiment of the switch shown in FIGS. 2A and 2B showing its internal structure.

FIGS. 3A and 3B are cross-sectional views along the section line 3A-3A in FIG. 2C of the embodiment of the switch shown in FIGS. 2A and 2B in its two switching states.

FIGS. 4A and 4B are plan views of first substrate and second substrate, respectively, of the embodiment of the switch shown in FIGS. 2A and 2B.

FIGS. 5A and 5B are cut-away plan views showing the internal structure of a second embodiment of a metallic contact switch in accordance with the invention in each of its switching states.

FIG. 5C is a cut-away plan view showing the internal structure of an embodiment of a double-pole, double-throw metallic contact switch in accordance with the invention in one of its switching states.

FIGS. 6A and 6B are cut-away plan views showing the internal structure of a third embodiment of a metallic contact switch in accordance with the invention in each of its switching states.

FIG. 7A is a cut-away plan view showing the internal structure of a fourth embodiment of a metallic contact switch in accordance with the invention one of its switching states.

FIG. 7B is a cut-away plan view of a variation on the embodiment of the switch in accordance with the invention shown in FIG. 7A.

FIGS. 8A-8D are cut-way plan views illustrating the operation of the embodiment shown in FIG. 7A of the switch in accordance with the invention.

FIGS. 9A and 9B are cut-away plan views showing the internal structure of a fifth embodiment of a metallic contact switch in accordance with the invention in each of its switching states.

FIG. 9C is a cross-sectional view along the section line 9C-9C in FIG. 9A of the embodiment of the switch shown in FIGS. 9A and 9B.

FIGS. 9D and 9E are plan views of the first and second substrates, respectively, of the embodiment of the switch shown in FIGS. 9A and 9B.

FIGS. 10A and 10B are cut-away views showing the internal structure of a sixth embodiment of a metallic contact switch in accordance with the invention.

FIGS. 11A and 11B are enlarged cut-away plan views showing part of a seventh embodiment of a metallic contact switch in accordance with the invention in which the structure of the cavity is modified to increase the stability of the switching states of the switch.

FIG. 11C is an enlarged cut-away plan view showing an alternative cavity structure that increases the stability of the switching states of embodiments of the switch in accordance with the invention.

FIGS. 12A and 12B are respectively a plan view and a cross-sectional view of an eighth embodiment of a metallic contact switch in accordance with the invention.

FIG. 12C is a cross-sectional view of a variation on the embodiment of the switch in accordance with the invention shown in FIGS. 12A and 12B.

FIGS. 13A, 13B and 13C are respectively two cut-away plan views and a cross-sectional view of a ninth embodiment of a metallic contact switch in accordance with the invention.

FIGS. 13D and 13E are plan views of the first and second substrates, respectively, of the embodiment of the switch in accordance with the invention shown in FIGS. 13A and 13B.

### DETAILED DESCRIPTION

The invention is based on the inventor's realization that a Lorentz actuator can be used to generate the motive force needed actuate a liquid metal switch.

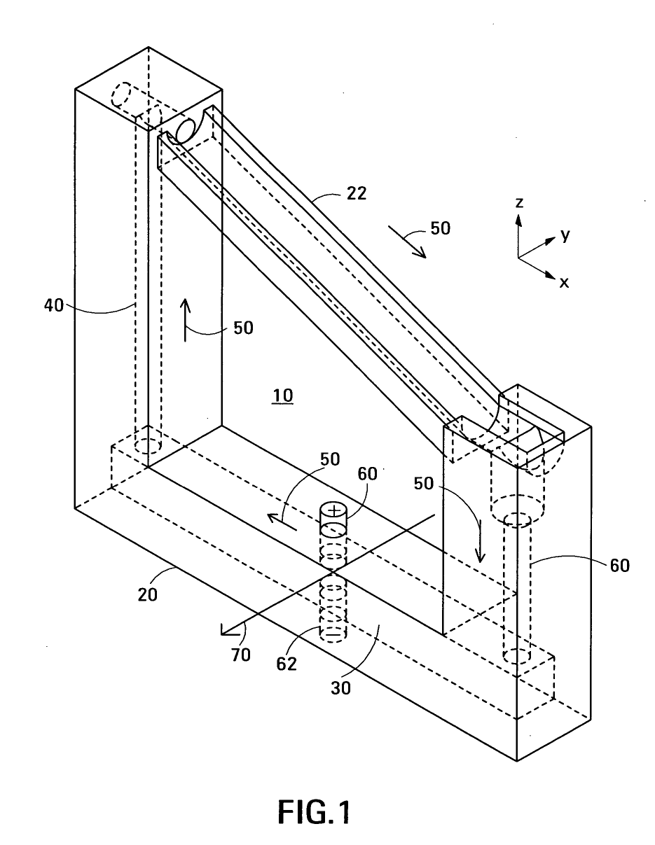

FIG. 1 is an isometric view of a liquid metal pump 10 that can be found on display in many science museums to demonstrate the Lorentz force. Pump 10 employs the Lorentz force to electromagnetically pump the liquid metal mercury. The Lorentz force is generated when an electric current flows in a direction non-parallel to a magnetic field.

In pump 10, an enclosed reservoir 20 holds a supply of mercury 30. The reservoir is made of an electrically non-conducting material such as glass. Opposed electrodes 60 and 62 extend through the walls of the reservoir part-way along its length into contact with the mercury. A riser tube 40 extends between one end of reservoir 20 and the upper end of an inclined open channel 22. A return tube 42 extends between the lower end of channel 22 and the other end of reservoir 20. A power supply (not shown) is connected to electrodes 60 and 62 by wires (not shown) to provide an electric current that flows through the portion of the mercury 30 located between the electrodes. The current flows through the mercury in the −z-direction shown in FIG. 1. A magnet (not shown) applies a magnetic field represented by an arrow 70 across the reservoir in the vicinity of the electrodes. The magnetic field is oriented in the +y-direction, orthogonal to the direction of the current flow through the mercury.

The Lorentz force is exerted on a charged object moving through a magnetic field. The electrons in the mercury that conduct the current between the electrodes 60 and 62 are charged objects. The direction of the Lorentz force is mutually orthogonal to the directions of the electric and magnetic fields. Thus, the Lorentz force is oriented in the −x-direction shown along the length of reservoir 20, i.e., in the −x-direction shown. The Lorentz force therefore the mercury along the length of reservoir 20 in the −x-direction. The pumped mercury flows up through riser tube 40 into channel 22. The mercury flows down channel 22, where its flow can be observed. The mercury returns to enclosure 20 by flowing down return tube 42. Arrows 50 indicate the mercury flow.

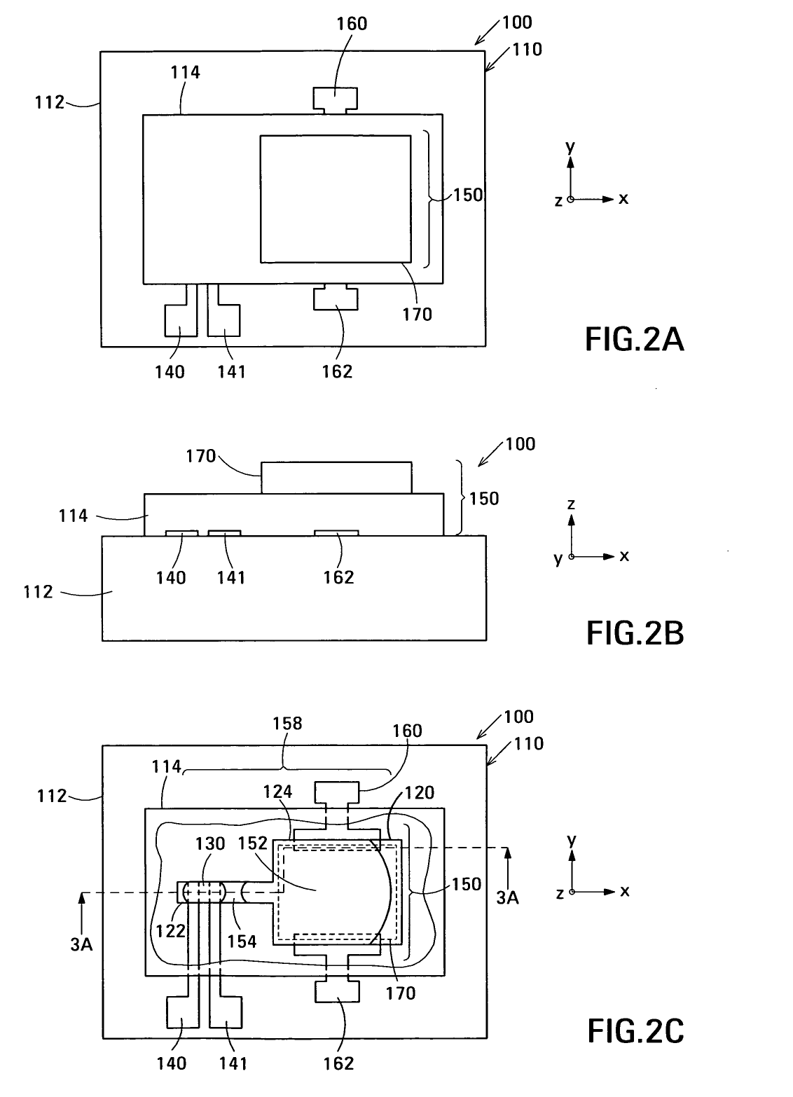

FIGS. 2A and 2B are respectively a plan view and a side elevation of a first embodiment 100 of a metallic contact electrical switch in accordance with the invention. FIG. 2C is a cut-away plan view of switch 100 showing its internal structure. In switch 100, a Lorentz actuator generates a motive force that is used to control the position of a conducting switching liquid relative to a pair of electrical switch contacts. The Lorentz actuator generates the motive force by a control current passing through a conducting actuating liquid located in a magnetic field supplied by a magnet. The control current is applied to the actuating liquid through opposed control electrodes.

Switch 100 has a housing 110 that defines a cavity 120 in which is located conducting switching liquid 130. Switch contacts 140 and 141 are also located in cavity 120 in electrical contact with switching liquid 130 in at least one of the switching states of switch 100. A Lorentz actuator 150 that comprises conducting actuating liquid 152 located in cavity 120 and is capable of movement in the cavity is mechanically coupled to the switching liquid 130 to change the switching state of switch 100.

In switch 100, cavity 120 is elongate and linear and has a switching portion 122 and an actuating portion 124. Switch contacts 140 and 141 are located in the switching portion 122 of cavity 120. Lorentz actuator 150 is composed of conducting actuating liquid 152 located in the actuating portion 124 of cavity 120; opposed control electrodes 160 and 162 located in the actuating portion 124 of cavity 120 in electrical contact with actuating liquid 152 in at least one of the switching states of switch 100, and a magnet 170 located adjacent the actuating portion 124 of cavity 120. The actuating portion 124 of cavity 120, control electrodes 160 and 162, and magnet 170 are arranged such that the direction of current flow through actuating liquid 152 between control electrodes 160 and 162, the direction of the magnetic field applied by magnet 170 to actuating liquid 152 and direction in which actuating liquid 152 is capable of moving in the actuating portion 124 of cavity 120 are mutually orthogonal.

Actuating liquid 152 is coupled to switching liquid 130 by an insulating fluid 154. Insulating fluid 154 electrically isolates switching liquid 130, and, hence, switch contacts 140 and 141, from actuating liquid 152 and from the electrical circuit formed in part by control electrodes 160 and 162 and actuating liquid 152. In applications in which it is acceptable to have a fluctuating DC voltage imposed on the signal switched by switch contacts 140 and 141, insulating fluid 154 may be omitted. In such embodiment, a single body of conducting liquid constitutes actuating liquid 152 and switching liquid 130. Switching liquid 130, actuating liquid 152 and, if present, insulating fluid 154 collectively constitute a moving element 158.

The terms conducting and insulating are used in this disclosure in a relative sense. A material described as conducting has a greater electrical conductivity than a material described as insulating. The ratio of the electrical conductivities of the conducting material and the insulating material depends on the application in which the switch will be used. A greater ratio is needed in applications that need the switch have a large ratio of OFF to ON resistance than in applications in which the switch having a smaller ratio of OFF to ON resistance are acceptable.

The example of magnet 170 is a permanent magnet. In other embodiments, magnet 170 is an electromagnet. The location of magnet 170 is indicated by a broken line in FIG. 2C.

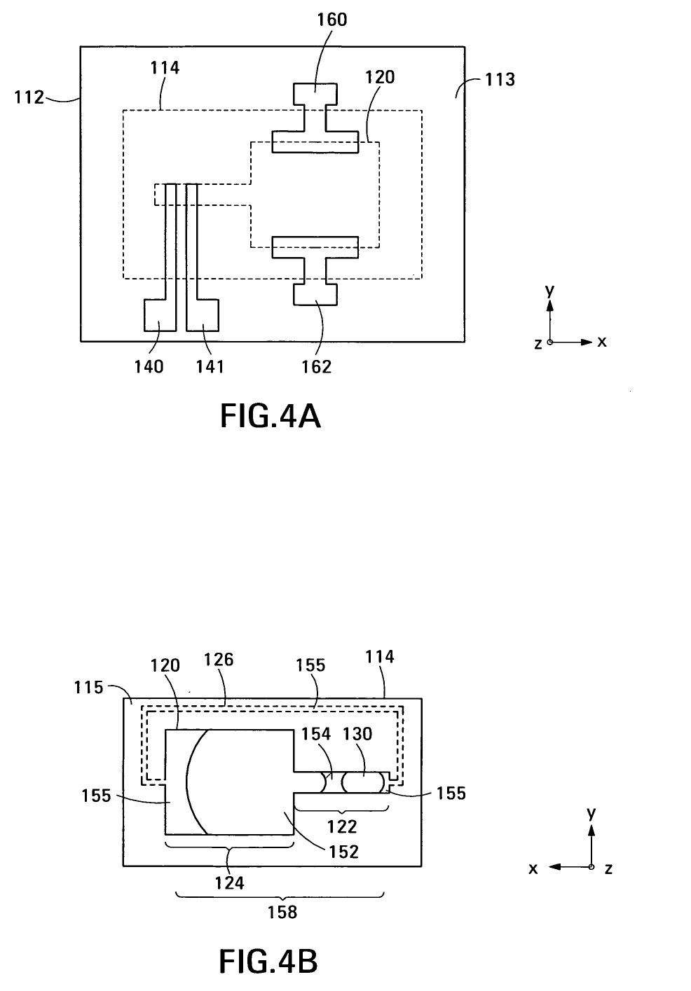

In the example shown in FIGS. 2A-2C, the portions of cavity 120 not occupied by moving element 158 are evacuated to enable the moving element to move freely in the x-direction in cavity 120 when the switching state of switch 100 changes. In other embodiments, cavity 120 additionally comprises a pressure equalizing portion that extends between the remote end of switching portion 122 and the remote end of actuating portion 124. The remote end of switching portion 122 is the end of switching portion 122 remote from actuating portion 124 and the remote end of actuating portion 124 is the end of actuating portion 124 remote from switching portion 122. The pressure equalizing portion allows moving element 158 to move freely in the x-direction in cavity 120 by enabling fluid filling the portions of cavity 120 not occupied by the moving element to flow back and forth between the remote end of switching portion 122 and the remote end of actuating portion 124 when the switching state of switch 100 changes. The pressure equalizing portion of cavity 120 will be described in more detail below with reference to FIG. 4B.

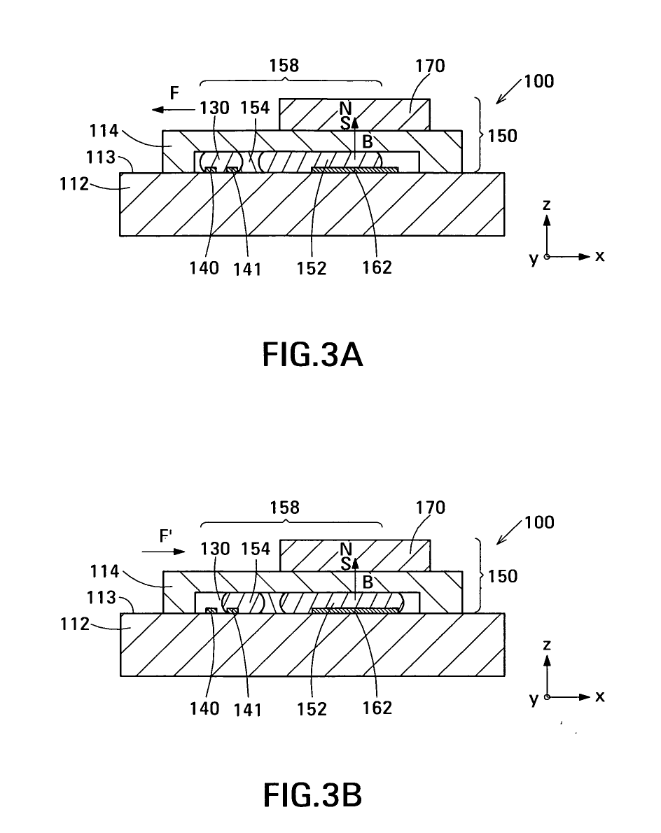

FIGS. 3A and 3B are cross-sectional views along the section line 3A-3A in FIG. 2C of switch 100 in its two switching states. FIGS. 3A and 3B show the direction of the magnetic field B that magnet 170 applies to actuating liquid 152 in Lorentz actuator 150. FIG. 3A shows the result of applying a control voltage between control electrode 162 and control electrode 160 (FIG. 2C). The control voltage causes a control current to flow through actuating liquid 152 in the +y-direction from control electrode 162 to control electrode 160. Interaction of the control current and magnetic field B applies a motive force F in the −x-direction to actuating liquid 152. Motive force F moves actuating liquid 152 in the −x-direction in the actuating portion 124 of cavity 120. Switching liquid 130 is coupled to actuating liquid 152 by insulating fluid 154. Thus, motive force F moves moving element 158 composed of switching liquid 130, insulating fluid 154 and actuating liquid 152 in the −x-direction to a position in the switching portion 122 of cavity 120 in which switching liquid 130 electrically connects switch contacts 140 and 141.

FIG. 3B shows the result of applying a control voltage between control electrode 160 and control electrode 162. The control voltage causes a control current to flow through actuating liquid 152 in the −y-direction from control electrode 160 to control electrode 162. Interaction of the control current and magnetic field B applies a motive force F′ in the +x-direction to actuating liquid 152. Motive force F′ moves moving element 158 in the +x-direction in cavity 120 to a position in which the electrical connection between switch contacts 140 and 141 provided by switching liquid 130 is broken.

The distance that moving element 158 moves in the x-direction depends on the temporal duration of the control voltage and the dynamics of the moving element in cavity 120. The control voltage is timed to move the moving element over a distance that alternately puts switching liquid 130 in contact with and out of contact with switch contacts 140 and 141. The distance through which the moving element moves can alternatively be defined by the amount of electrical charge that passes between control electrodes 160 and 162 and vice versa. Other ways of defining the distance through which moving element 158 moves in cavity 120 are described below.

As shown in FIGS. 3A and 3B, housing 110 is composed of a first substrate 112 and a second substrate 114. Second substrate 114 is bonded to first substrate 112. First substrate 112 and second substrate 114 are shown in more detail in FIGS. 4A and 4B, respectively.

FIG. 4A is a plan view of first substrate 112. Broken lines show the locations of second substrate 114 on the first substrate and of cavity 120 in the second substrate. First substrate 112 has a planar major surface 113 (also shown in FIG. 3A) on which switch contacts 140 and 141 and control electrodes 160 and 162 are located.

Second substrate 114 has a planar major surface 115 that is juxtaposed with surface 113 of first substrate 112 in switch 100. FIG. 4B is a view of the major surface 115 of second substrate 114. Cavity 120, composed of switching portion 122 and actuating portion 124, is defined in substrate 114. In the example shown, the width, i.e., dimension in the y-direction, of actuating portion 124 is greater than that of switching portion 122. Accordingly, actuating portion 124 is greater in cross-sectional area than switching portion 122. Alternatively, switching portion 122 and actuating portion 124 are equal in either or both of width and cross-sectional area.

Cavity 120 is located in substrate 114 such that, when substrates 112 and 114 are assembled to form switch 100, part of each of the switch contacts 140 and 141 is located inside the switching portion 122 of cavity 120 in contact with switching liquid 130 and part of each of the control electrodes 160 and 162 is located inside the actuating portion 124 of cavity 120 in contact with actuating liquid 152.

FIG. 4B also shows switching liquid 130 occupying part of switching portion 122 of cavity 120, actuating liquid 152 occupying parts of switching portion 122 and actuating portion 124, and insulating fluid 154 occupying part of switching portion 122 between the parts occupied by switching liquid 130 and actuating liquid 152.

FIG. 4B also shows an embodiment of cavity 120 additionally having the above-mentioned optional pressure equalizing portion 126 defined in substrate 114. Pressure equalizing portion 126 extends between the remote end of the switching portion 122 and the remote end of actuating portion 124. The portion of cavity 120 not occupied by moving element 158 is filled with an insulating fluid 155. Pressure equalizing portion 126 allows insulating fluid 155 to flow back and forth between the remote end of switching portion 122 and the remote end of actuating portion 124 to equalize pressure across moving element 158 as switch 100 changes state. The material of insulating fluid 155 may be the same as, or different from, that of insulating fluid 154.

The cross-sectional area and length of the pressure equalizing portion 126 of cavity 120 and the physical properties of insulating fluid 155 influence the dynamic switching properties of switch 100. In some embodiments, pressure equalizing portion 126 is dimensioned and insulating fluid 155 is chosen to provide switch 100 with specific dynamic switching properties. In other embodiments, pressure equalizing portion 126 is dimensioned and insulating fluid 155 is chosen to impart a negligible change on the dynamic switching properties on switch 100. Pressure equalizing portion 126 may alternatively be defined at least in part in first substrate 112 (FIG. 4A).

Switch 100 is a single-pole, single-throw, i.e., ON-OFF, switch. Other embodiments of a switch in accordance with the invention provide additional poles and additional throws.

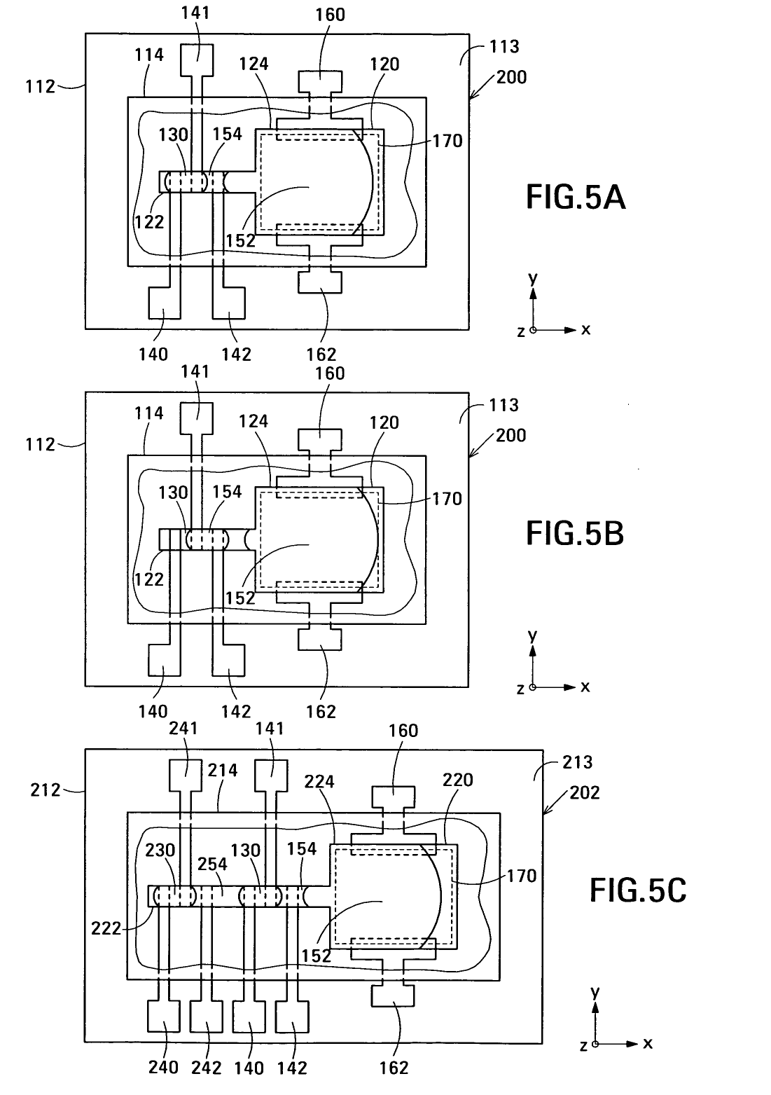

FIGS. 5A and 5B are cut-away plan views showing the internal structure of a second embodiment 200 of a metallic contact switch in accordance with the invention in each of its switching states. Switch 200 is a single-pole, double-throw switch, i.e., a two-way switch. Elements of switch 200 that correspond to elements of above-described switch 100 are indicated by the same reference numerals and will not be described again here.

Switch 200 has a third switch contact 142 located on the major surface 113 of substrate 112. Switch contact 142 is located in and extends from the switching portion 122 of cavity 120 and is in electrical contact with switching liquid 130 in one of the switching states of switch 200. In this embodiment, switch contacts 140, 141 and 142 are arrayed in order in the x-direction along the length of switching portion 122. In this disclosure, the term length used in connection with an element, such as cavity 120, denotes the dimension of the element in the x-direction. Switch contacts 140, 141 and 142 have a nominally uniform pitch, i.e., switch contacts 140, 141 and 142 are separated in the x-direction by nominally-equal distances. However, a functioning switch will be obtained with some deviation from a uniform pitch.

In the example shown, switch contact 141 is located on the opposite side of switching portion 122 from switch contacts 140 and 142, i.e., common switch contact 141 extends in the +y-direction from switching portion 122, whereas switch contacts 140 and 142 extend in the −y-direction from switching portion 122. This arrangement reduces capacitance between common switch contact 141 and switch contacts 140 and 142. In other embodiments, switch contacts 140, 141 and 142 are all located on the same side of switching portion 122, i.e., all three switch contacts extend from switching portion 122 in the same direction.

To provide double-throw switching, the length of switching liquid 130 in the switching portion 122 of cavity 120 is greater than the distance between switch contacts 140 and 141, but less than the distance between the adjacent edges of switch contacts 140 and 142. FIG. 5A shows switch 200 in one of its switching states in which switching liquid 130 contacts switch contacts 140 and 141, and switch contact 142 contacts insulating fluid 154. In this switching state, switching liquid 130 electrically connects switch contact 140 to switch contact 141, and switch contact 142 is electrically isolated.

FIG. 5B shows switch 200 after a control current has passed from control electrode 160 to control electrode 162 to generate a motive force in the +x-direction.

The motive force has moved actuating liquid 152 in the +x-direction and the actuating liquid has moved switching liquid 130 in the +x-direction by a distance approximately equal to the pitch of switch contacts 140, 141 and 142. The movement of switching liquid 130 has put switching liquid 130 in contact with switch contacts 141 and 142. In this switching state, switching liquid 130 electrically connects switch contact 142 to switch contact 141, and switch contact 140 is electrically isolated. Switch 200 is returned to its switching state shown in FIG. 5A by passing a control current from control electrode 162 to control electrode 160.

FIG. 5C is a cut-away plan view showing the internal structure of an embodiment 202 of a double-pole, double-throw switch in one of its switching states. Switch 202 is based on single-pole, double-throw, switch 200 described above with reference to FIGS. 5A and SB. Elements of switch 202 that correspond to elements of the switches described above with reference to FIGS. 2A, 2B, 5A and 5B are indicated by the same reference numerals and will not be described again here.

In switch 202, switch contacts 240, 241 and 242 are arrayed in the x-direction on major surface 213 of first substrate 212 next to switch contacts 140, 141 and 142. Switch contacts 240, 241 and 242 have the same pitch as switch contacts 140, 141 and 142. Switch contact 242 is separated from switch contact 140 by a distance different from the pitch of the switch contacts. In another embodiment, switch contact 242 is separated from switch contact 140 by a distance equal to the pitch of the switch contacts.

Defined in second substrate 214 is a cavity 220 similar to cavity 120 shown in FIG. 5A. Cavity 220 has a switching portion 222 and an actuating portion 224. Relative to switching portion 122 of cavity 120 (FIG. 5A), switching portion 222 is extended in the −x-direction to accommodate switch contacts 240, 241 and 242 in addition to switch contacts 140, 141 and 142. Switching liquid 230 and insulating fluid 254 are disposed in tandem with switching liquid 130 and insulating fluid 154 in switching portion 222. The length of switching liquid 230 and the length of switching liquid 130 in the switching portion 222 of cavity 220 are approximately equal. The length of insulating fluid 254 in switching portion 222 is approximately equal to the distance between switch contacts 140 and 242.

FIG. 5C shows switch 202 in the one of its switching states corresponding to the switching state shown in FIG. 5A. Switching liquid 130 electrically contacts switch contacts 140 and 141, switch contact 142 contacts insulating fluid 154, switching liquid 230 electrically contacts switch contacts 240 and 241, and switch contact 242 contacts insulating fluid 254. In this switching state, switching liquid 130 electrically connects switch contact 140 to switch contact 141, switch contact 142 is electrically isolated, switching liquid 230 electrically connects switch contact 240 to switch contact 241, and switch contact 242 is electrically isolated.

In the switching state (not shown) of switch 202 corresponding to that shown in FIG. 5B, switching liquid 130 contacts switch contacts 141 and 142, switch contact 140 contacts insulating fluid 254, switching liquid 230 contacts switch contacts 241 and 242, and switch contact 240 is electrically isolated. In this switching state, switching liquid 130 electrically connects switch contact 141 to switch contact 142, switch contact 140 is electrically isolated, switching liquid 230 electrically connects switch contact 241 to switch contact 242, and switch contact 240 is electrically isolated.

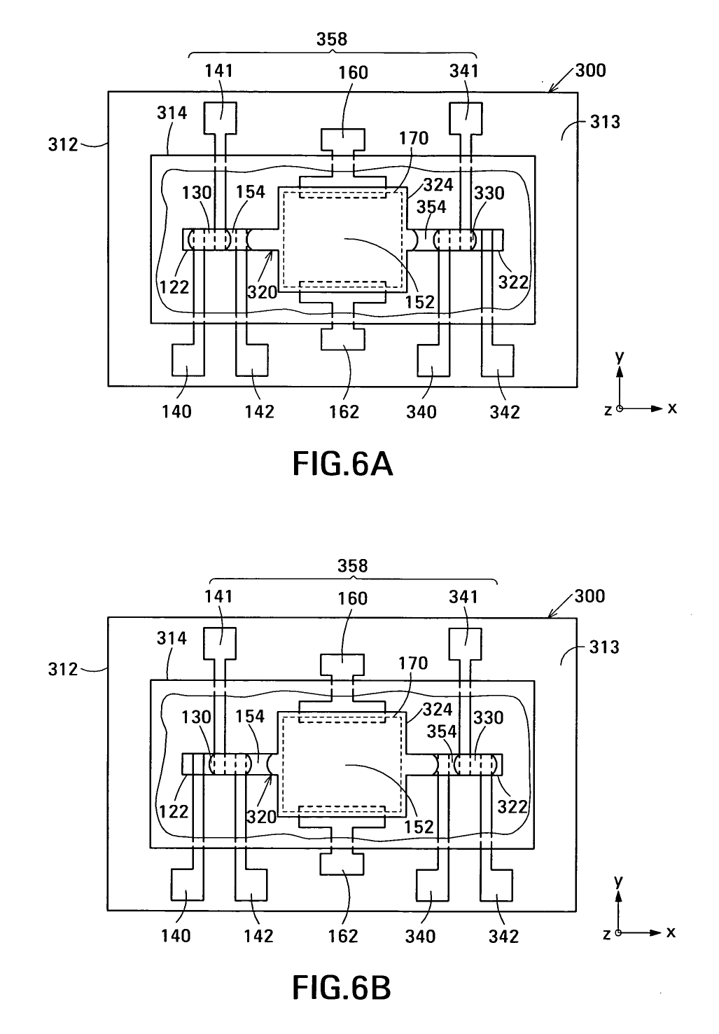

FIGS. 6A and 6B are cut-away plan views showing the internal structure of a third embodiment 300 of a metallic contact switch in accordance with the invention in each of its switching states. Switch 300 is a double-pole, double-throw switch. Elements of switch 300 that correspond to elements of the switches described above are indicated by the same reference numerals and will not be described again here.

Defined in second substrate 314 is cavity 320 having a switching portion 122, an actuating portion 324 and a switching portion 322 arranged in tandem in the x-direction. Located in switching portion 122 is part of actuating liquid 152, insulating fluid 154 and switching liquid 130 in an arrangement similar to that of actuating liquid 152, insulating fluid 154 and switching liquid 130 in the switching portion 122 of cavity 120 described above with reference to FIGS. 2A-2C. Actuating liquid 152 additionally fills actuating portion 324 of cavity 320 and part of switching portion 322. Switching portion 322 additionally accommodates insulating fluid 354 and switching liquid 330 arranged in tandem in an arrangement that is a mirror image of the arrangement of insulating fluid 154 and switching liquid 130 in switching portion 322.

Switch 300 has three switch contacts 140, 141 and 142 located on the major surface 313 of substrate 312. Switch contacts 140, 141 and 142 are located in and extend from switching portion 122 of cavity 320 in a manner similar to that described above with reference to FIG. 5A. Switch 300 additionally has three switch contacts 340, 341 and 342 located on major surface 313 of substrate 312. Switch contacts 340, 341 and 342 are located in and extend from the switching portion 322 of cavity 320. Switch contacts 340, 341 and 342 are arrayed in order in the −x-direction along the length of switching portion 322. Switch contacts 340, 341 and 342 have a nominally uniform pitch as described above, but a functioning switch will be obtained even with some deviation from uniformity. All the switch contacts 140-142, 340-342 have the same pitch. In the example shown, switch contact 341 extends from switching portion 322 in the opposite direction to switch contacts 340 and 342, but may alternatively extend from switching portion 322 in the same direction as switch contacts 340 and 342.

The length of switching liquid 130 in switching portion 122 of cavity 320 is greater than the distance between switch contacts 140 and 141, but less than the distance between the adjacent edges of switch contacts 140 and 142 as described above. The length of switching liquid 330 in switching portion 322 is greater than the distance between switch contacts 340 and 341, but less than the distance between the adjacent edges of switch contacts 340 and 342.

FIG. 6A shows switch 300 in one of its switching states in which switching liquid 130 makes contact with switch contacts 140 and 141, switch contact 142 contacts insulating fluid 154, switching liquid 330 makes contact with switch contacts 340 and 341 and switch contact 342 is electrically isolated. Thus, switching liquid 130 electrically connects switch contact 140 to switch contact 141, switch contact 142 is electrically isolated, switching liquid 330 electrically connects switch contact 340 to switch contact 341, and switch contact 342 is electrically isolated.

FIG. 6B shows switch 300 after a control current has passed from control electrode 160 to control electrode 162 to generate a motive force that has moved actuator liquid 152 in the +x-direction. Actuator liquid moving the +x-direction has moved moving element 358, composed of switching liquid 130, insulating fluid 154, actuating liquid 152, insulating fluid 354 and switching liquid 330, in the +x-direction. Switching liquid 130 and switching liquid 330 have moved through a distance equal to the pitch of the switch contacts. The movement of moving element 358 puts switching liquid 130 in contact with switch contacts 141 and 142, switching liquid 330 in contact with switch contacts 341 and 342 and insulating fluid 354 in contact with switch contact 340. Thus, switching liquid 130 electrically connects switch contact 141 to switch contact 142, switch contact 140 is electrically isolated, switching liquid 330 electrically connects switch contact 341 to switch contact 342, and switch contact 340 is electrically isolated.

A double-pole, single-throw switch can be made based on the embodiment shown in FIGS. 6A and 6B by omitting switch contact 140 or switch contact 142 and by omitting switch contact 340 or switch contact 342. The identity of the omitted switch contacts determines whether the poles of the switch are ON (or OFF) simultaneously or alternately. Similarly, double-pole, single-throw switch can be made based on the embodiment shown in FIG. 5C by omitting switch contact 140 or switch contact 142 and by omitting switch contact 240 or switch contact 242. The identity of the omitted switch contacts determines whether the poles of the switch are ON (or OFF) simultaneously or alternately.

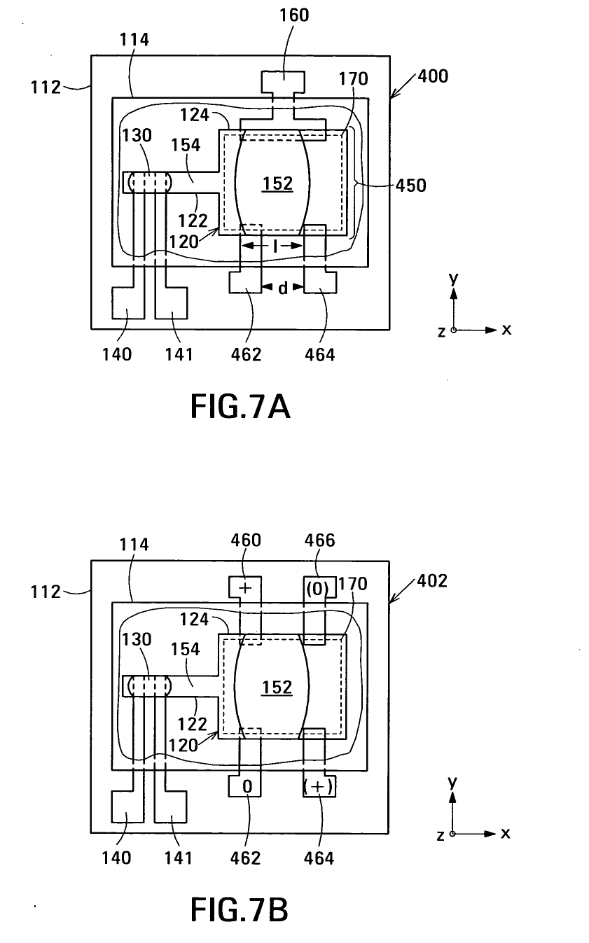

FIG. 7A is a cut-away plan view showing the internal structure of a fourth embodiment 400 of a metallic contact switch in accordance with the invention one of its switching states. Elements of switch 400 that correspond to elements of the switches described above are indicated by the same reference numerals and will not be described again here. Switch 400 is a single-pole, single-throw switch in which Lorentz actuator 450 is configured to define the travel of actuating liquid 152 in the actuating portion 124 of cavity 120. The defined travel of actuating liquid 152 in turn defines the travel of switching liquid 130 in the switching portion 122 of cavity 120 relative to switch contacts 140 and 141. The other switch embodiments described herein may be similarly modified to incorporate a Lorentz actuator in which the actuating liquid has a defined travel.

In switch 400, control electrodes 160, 462 and 464 are located in actuating portion 124 of cavity 120. Control electrode 160 is located on one side of actuating portion 124 and, in the example shown, is elongate in the x-direction. Control electrodes 462 and 464 are located opposite control electrode 160 on the other side of actuating portion 124, and are separated from one another in the x-direction and from control electrode 160 in the y-direction. Each of the control electrodes 462 and 464 is smaller in length than control electrode 160. Alternatively, with proper positioning of control electrode 160, electrodes 160, 462 and 464 may all be approximately equal in length.

Actuating liquid 152 occupies part of the length of the actuating portion 124 of cavity 120. Insulating fluid 154 occupies part of the actuating portion 124 and part of the switching portion 122 of cavity 120 between actuating liquid 152 and switching liquid 130.

Denote the desired travel of switching liquid 130 by t₁, the cross-sectional area of the switching portion 122 of cavity 120 by A₁ and the cross-sectional area of the actuating portion 124 of cavity 120 by A₂. To move switching liquid 130 a distance of t₁ requires that the travel t₂ of actuating liquid 152 be t₂=t₁×A₁/A₂. The difference between the length l of actuating liquid 152 in actuating portion 124 and the distance d between adjacent edges of control electrodes 462 and 464 defines the travel t₂ of actuating liquid 152, i.e., t₂=l−d. Thus, difference between the length l of actuating liquid 152 and the distance d between adjacent edges of control electrodes 462 and 464 is given by:
l−d=t₁×A₁/A₂.

FIG. 7A shows switch 400 in an exemplary initial switching state in which switching liquid 130 electrically connects switch contacts 140 and 141 and actuating liquid 152 is in electrical contact with control electrode 462 and control electrode 160, but does not make electrical contact with control electrode 464.

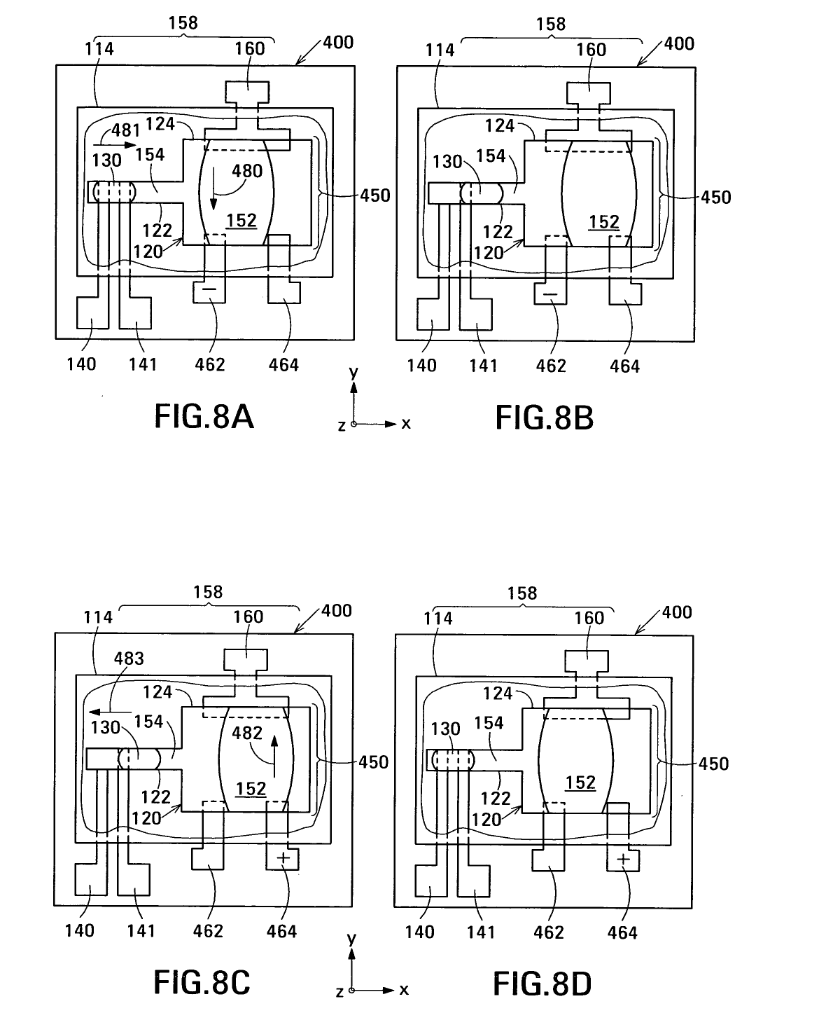

FIGS. 8A-8D illustrate the operation of switch 400 starting at the exemplary initial switching state shown in FIG. 7A. To change the switching state of switch 400 from the initial switching state shown in FIG. 7A, a negative control voltage is applied between control electrode 160 (nominally ground) and control electrode 462, as shown in FIG. 8A. Consequently, a control current, represented by arrow 480, flows in the −y-direction from control electrode 160 to control electrode 462. Control current 480 and magnetic field B (see FIG. 3A) generate a motive force, represented by an arrow 481, in the +x-direction. Motive force 481 moves actuating liquid 152 and, hence, moving element 158, composed of actuating liquid 152, insulating fluid 154 and switching liquid 130, in the +x-direction. As a result of this motion, actuating liquid 152 moves into contact with control electrode 464 and switching liquid 130 moves out of contact with switch contact 140. The loss of contact between switching liquid 130 and switch contact 140 breaks the electrical circuit between switch contacts 140 and 141.

Further motion of actuating liquid 152 in the x-direction in response to motive force 481 causes the actuating liquid to break contact with control electrode 462, as shown in FIG. 8B. This stops the flow of the control current through the actuating liquid, and, as a result, Lorentz actuator 450 generates no more motive force. With no motive force applied, moving element 158 decelerates to a stop with actuating liquid 152 in contact with control electrodes 160 and 464 and switching liquid 130 in contact only with switch contact 141. The control voltage is then removed from control electrode 462.

Switch 400 remains in the switching state shown in FIG. 8B until a positive control voltage is applied between control electrode 160 (nominally ground) and control electrode 464, as shown in FIG. 8C. A control current, represented by arrow 482, flows in the +y-direction from control electrode 464 to control electrode 160. Control current 482 and magnetic field B (see FIG. 3A) generate a motive force, represented by an arrow 483, in the −x-direction. Motive force 483 moves actuating liquid 152 and, hence, moving element 158, in the −x-direction. As a result of this motion, actuating liquid 152 moves back into contact with control electrode 462 and switching liquid 130 moves into contact with switch contact 140. The contact between switching liquid 130 and switch contact 140 re-establishes the electrical circuit between switch contacts 140 and 141.

Further motion of actuating liquid 152 in the −x-direction in response to motive force 483 causes the actuating liquid to break contact with control electrode 464, as shown in FIG. 8D. This stops the flow of the control current through the actuating liquid, and, as a result, Lorentz actuator 450 generates no more motive force. With no motive force applied, moving element 158 decelerates to a stop with the actuating liquid in contact with control electrodes 160 and 462 and switching liquid 130 in contact with switch contact 140 and switch contact 141. The control voltage is then removed from control electrode 160. Switch 400 has returned to its exemplary initial switching state shown in FIG. 7A.

FIG. 7B is a cut-away plan view of a variation 402 on switch 400 shown in FIG. 7A in which the need for a bipolar control voltage is eliminated. In the embodiment shown in FIG. 7B, control electrode 160 is replaced by a control electrode 460 located in actuating portion 124 opposite control electrode 462 and a control electrode 466 located in actuating portion 124 opposite control electrode 464. Control electrodes 460 and 466 are typically mirror images of control electrodes 462 and 464, respectively.

In operation, a control voltage is applied between control electrode 462 (nominally ground) and control electrode 460 (high) to generate a motive force in the +x-direction to change switch 402 from the switching state shown in FIG. 7B to a switching state similar to that shown in FIG. 8B. In this switching state, the movement of actuating liquid 152 in the +x-direction breaks the electrical circuit shown in FIG. 7B between control electrodes 460 and 462 and establishes an electrical circuit between control electrodes 464 and 466. Switch 402 is returned to its switching state shown in FIG. 7B by applying a control voltage between control electrode 466 (nominally ground) and control electrode 464 (high) to generate a motive force in the −x-direction. The motion of the actuating liquid in the −x-direction re-establishes the electrical circuit between control electrodes 460 and 462 and breaks the electrical circuit between control electrodes 464 and 466.

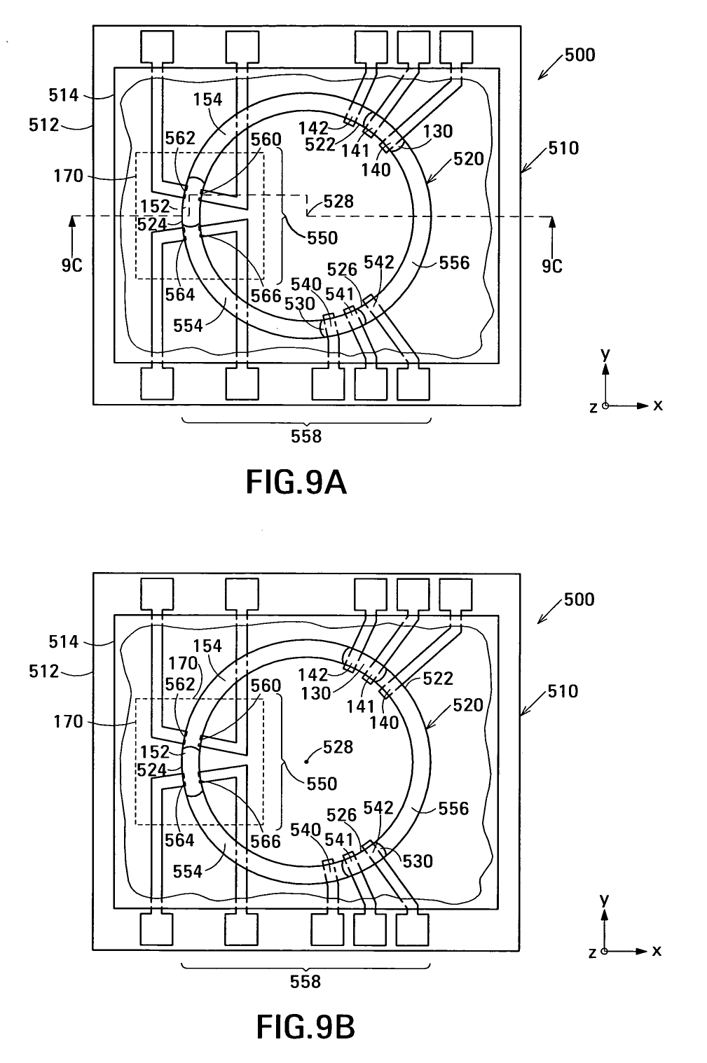

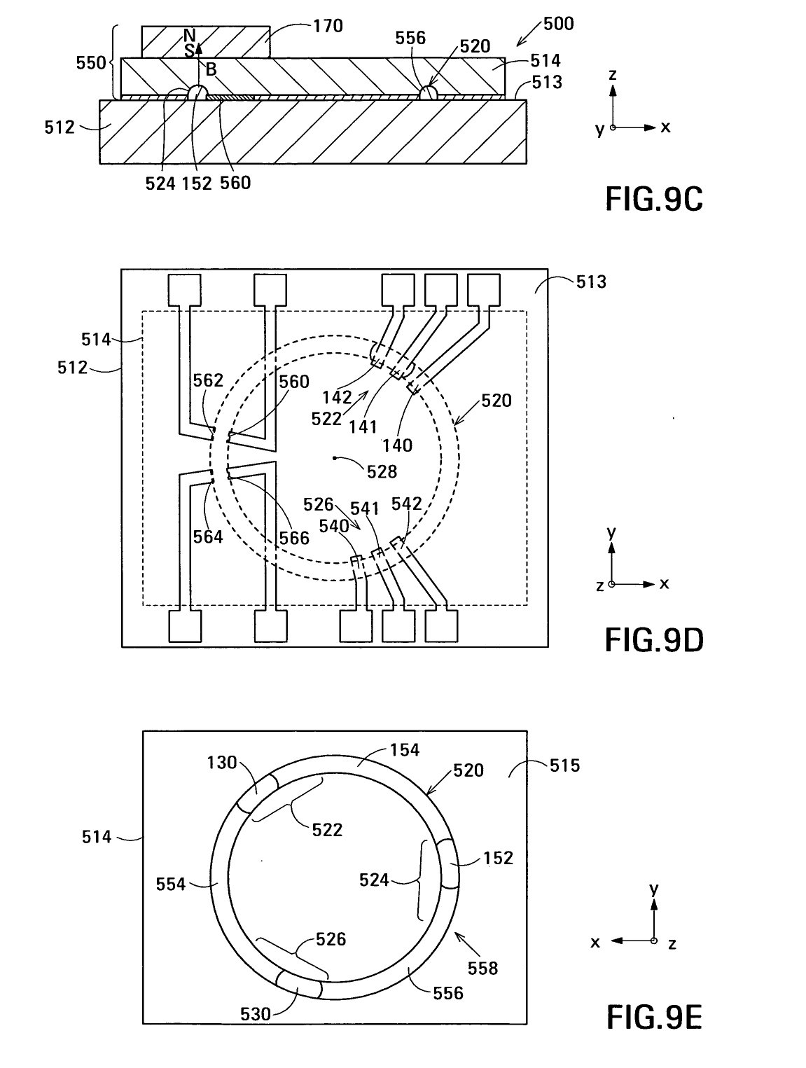

FIGS. 9A and 9B are cut-away plan views showing the internal structure of a fifth embodiment 500 of a metallic contact switch in accordance with the invention in each of its switching states. Switch 500 has a toroidal cavity. FIG. 9C is a cross-sectional view along the section line 9C-9C in FIG. 9A. FIGS. 9D and 9E are plan views of the first and second substrates, respectively, of switch 500. The example of switch 500 shown is a double-pole, double-throw switch. Other examples have different numbers of poles and/or throws. Elements of switch 500 that correspond to elements of the switches described above with reference to FIGS. 2A, 2B, 5A, SB, 6A and 6B are indicated by the same reference numerals and will not be described again here.

Switch 500 is composed of a housing 510 that defines a toroidal cavity 520;

conducting switching liquid 130 located in cavity 520; switch contacts 140, 141 and 142 located in cavity 520 in electrical contact with switching liquid 130 in at least one of the switching states of switch 500; and a Lorentz actuator 550 mechanically coupled to switching liquid 130 to change the switching state of the switch. Switching liquid 130 is located in a switching portion 522 of cavity 520. Switch 500 also has conducting switching liquid 530 located in a switching portion 526 of cavity 520, and switch contacts 540, 541 and 542 located in switching portion 526 of cavity 520 in electrical contact with switching liquid 530 in at least one of the switching states of switch 500.

Lorentz actuator 550 is composed of conducting actuating liquid 152 located in an actuating portion 524 of cavity 520, control electrodes 560 and 562 located in actuating portion 524 of cavity 520 in electrical contact with actuating liquid 152 and a magnet 570 located adjacent actuating portion 524 of cavity 520. The actuating portion 524 of cavity 520, control electrodes 560 and 562, and magnet 570 are arranged such that the direction of current flow through actuating liquid 152 between control electrodes 560 and 562, the direction of the magnetic field applied by magnet 570 to actuating liquid 152 and the resulting direction of motion of actuating liquid 152 in cavity 520 are mutually orthogonal.

In the example of Lorentz actuator 550 shown, control electrodes 560 and 562 are in electrical contact with actuating liquid 152 in one of the switching states of switch 500. Lorentz actuator 550 additionally has opposed control electrodes 564 and 566 located in actuating portion 524 of cavity 520 in electrical contact with actuating liquid 152 in the other of the switching states of switch 500. Together with control electrodes 560 and 562, control electrodes 564 and 566 define the travel of actuating liquid 152, and, hence, switching liquid portions 130 and 530, in cavity 520 in a manner similar to that described above with reference to FIG. 7B.

Insulating fluid portions 154 and 554 mechanically couple actuating liquid 152 of Lorentz actuator 550 to switching liquid 130 and switching liquid 530, respectively. Additionally insulating fluid portion 556 mechanically couples switching liquid 130 and to switching liquid 530.

In the example of switch 500 shown FIGS. 9A-9C, housing 510 is composed of a first substrate 512 and a second substrate 514 bonded to first substrate 512. FIG. 9E shows the major surface 515 of second substrate 514 that faces first substrate 512. Toroidal cavity 520 extends into second substrate 514 from major surface 515. Also shown in FIG. 9E are switching portion 522, actuating portion 524 and switching portion 526 of cavity 520. Switching portion 522, actuating portion 524 and switching portion 526 are arranged in tandem. In the example shown, switching portion 522, actuating portion 524 and switching portion 526 are simply circumferential regions of cavity 520 and do not differ from one another structurally. In other embodiments, switching portion 522, actuating portion 524 and switching portion 526 differ from one another structurally. For example, in one embodiment, actuating portion 524 differs in cross-sectional area from switching portions 522 and 526. In another embodiment, one or more of the portions of cavity 520 between switching portion 522, actuating portion 524 and switching portion 526 differ in cross-sectional area from switching portion 522, actuating portion 524 and switching portion 526 to impose specific dynamic switching properties on switch 500.

FIG. 9E also shows switching liquid 130, actuating liquid 152 and switching liquid 530 located in switching portion 522, actuating portion 524 and switching portion 526, respectively, of cavity 520, and insulating fluid portions 154, 556 and 554 occupying the portions of cavity 520 not occupied by switching liquid 130, actuating liquid 152 and switching liquid 556.

FIG. 9D shows the major surface 513 of first substrate 512 that faces second substrate 514. The positions on first substrate 512 of second substrate 514 and of toroidal cavity 520 in the second substrate are indicated in FIG. 9D by broken lines. Located on major surface 513 are three switch contacts 140, 141 and 142 located in and extending radially from the switching portion 522 of cavity 520.

Additionally, three switch contacts 540, 541 and 542 are located on major surface 513 circumferentially offset in the clockwise direction from switch contacts 140, 141 and 142. Switch contacts 540-542 are located in and extend radially from the switching portion 526 of cavity 520. Switch contacts 140-142 are circumferentially arrayed in counterclockwise order along switching portion 522 and switch contacts 540-542 are circumferentially arrayed in counterclockwise order along switching portion 526. Switch contacts 140-142 have nominally uniform angular separations, but a functioning switch will be obtained even with some deviation from uniformity. Switch contacts 540-542 have nominally uniform angular separations equal to those of switch contacts 140-142, but a functioning switch will be obtained even with some deviation from uniformity and equality.

Referring additionally to FIGS. 9A-9B, the circumferential distance between the ends of switching liquid 130 in the switching portion 522 of cavity 520 is greater than the circumferential distance between switch contacts 140 and 141, but less than the circumferential distance between the adjacent edges of switch contacts 140 and 142. The circumferential distance between the ends of switching liquid 530 in switching portion 526 is greater than the circumferential distance between switch contacts 540 and 541, but less than the circumferential distance between the adjacent edges of switch contacts 540 and 542.

Control electrodes 560, 562, 564 and 566 are also located on the major surface 513 of first substrate 512. Control electrodes 560 and 562 are located radially opposite one another on opposite sides of the actuating portion 524 of cavity 520 and extend radially outwardly and inwardly, respectively, from the actuating portion. Control electrodes 566 and 564 are located radially opposite one another on opposite sides of the actuating portion 524 of cavity 520, are circumferentially offset in the counterclockwise direction from control electrodes 560 and 562, respectively, and extend radially outwardly and inwardly, respectively, from the actuating portion.

The angle through which the actuating liquid 152 of Lorentz actuator 550 rotates about the center 528 of toroidal cavity 520 is given by the difference between the angle subtended at center 528 by actuating liquid 152 and the angle subtended at center 528 by the adjacent edges of control electrodes 562 and 564.

FIG. 9A shows switch 500 in one of its switching states in which switching liquid 130 is in electrical contact with switch contacts 140 and 141, and switch contact 142 contacts insulating fluid 154, and switching liquid 530 is in electrical contact with switch contacts 540 and 541 and switch contact 542 contacts insulating fluid 556. Thus, switching liquid 130 electrically connects switch contact 140 to switch contact 141, switch contact 142 is electrically isolated, switching liquid 530 electrically connects switch contact 540 to switch contact 541, and switch contact 542 is electrically isolated. Moreover, control electrodes 560 and 562 are in electrical contact with actuating liquid 152 whereas control electrodes 564 and 566 are in contact with insulating fluid 554.

FIG. 9B shows switch 500 after a control voltage has been applied between control electrode 560 and control electrode 562. A control current flowing through actuating liquid 152 generates a motive force that moves actuating liquid 152 clockwise until the electrical contact between actuating liquid 152 and control electrodes 560 and 562 breaks. The counterclockwise motion of actuating liquid 152 moves moving element 558, composed of actuating liquid 152, insulating fluid 154, switching liquid 130, insulating fluid 556, switching liquid 530 and insulating fluid 554, counterclockwise through an angle about center 528 approximately equal to the angular pitch of the switch contacts. The movement of moving element 558 puts insulating fluid 556 in contact with switch contact 140, switching liquid 130 in contact with switch contacts 141 and 142, insulating fluid 554 in contact with switch contact 540 and switching liquid 530 in contact with switch contacts 541 and 542. Thus, switch contact 140 is electrically isolated, switching liquid 130 electrically connects switch contact 141 to switch contact 142, switch contact 540 is electrically isolated and switching liquid 530 electrically connects switch contact 541 to switch contact 542. Finally, the counterclockwise movement of actuating liquid 152 puts actuating liquid 152 in contact with control electrodes 564 and 566.

To return switch 500 to its switching state shown in FIG. 9A, a control voltage is applied control electrodes 564 and 566. The resulting control current flowing through actuating liquid 152 generates a motive force that moves actuating liquid 152 clockwise until the electrical contact between actuating liquid 152 and control electrodes 564 and 566 breaks. The clockwise motion of actuating liquid 152 moves moving element 558 clockwise through an angle about center 528 approximately equal to the angular pitch of the switch contacts. This restores switch 500 it its switching state described above with reference to FIG. 9A.

A double-pole, single-throw switch can be made based on the double-pole-double-throw example shown in FIGS. 9A and 9B by omitting switch contact 140 or switch contact 142 and by omitting switch contact 540 or switch contact 542. The identity of the omitted switch contacts determines whether the poles of the switch are ON (or OFF) simultaneously or alternately.

More poles can be incorporated into the switch 500 described above with reference to FIGS. 9A and 9B by increasing the number of portions of switching liquid in cavity 520. The portions of switching liquid are circumferentially spaced from one another and from switching liquid 130, switching liquid 530 and actuating liquid 152. Portions of insulating fluid fill the portions of cavity 520 not occupied by the switching liquid portions and the actuating liquid. Additional sets of switch contacts are located on the major surface 513 of first substrate 512 in locations corresponding to the locations of the additional switching liquid portions.

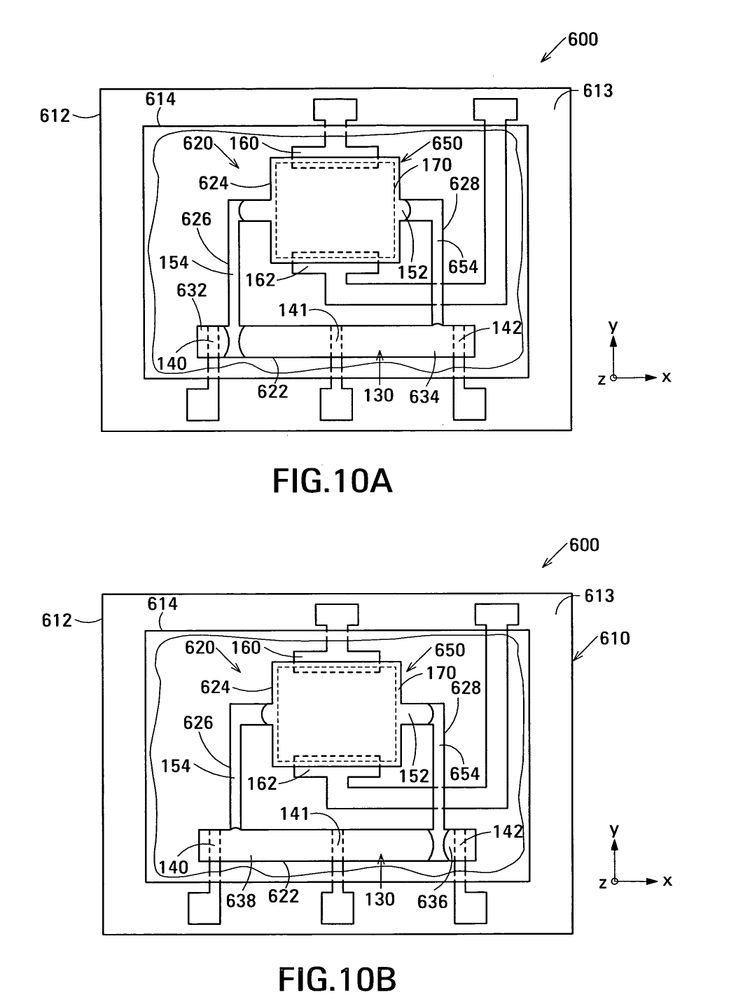

FIGS. 10A and 10B are cut-away views showing the internal structure of a sixth embodiment 600 of a metallic contact switch in accordance with the invention. In switch 600, a Lorentz actuator is used to control the electrical continuity of a conducting switching liquid relative to a set of switch contacts. In this embodiment, the switch contacts remain in continuous electrical contact with the switching liquid. The Lorentz actuator generates an actuation force by passing a control current through a conducting actuating liquid located in a magnetic field. The control current is provided to the actuating liquid via opposed control electrodes.

Switch 600 is composed of a housing 610 that defines a cavity 620; conducting switching liquid 130 located in cavity 620; switch contacts 140, 141 and 142 located in cavity 620 in electrical contact with switching liquid 130 in both of the switching states of switch 600; and a Lorentz actuator 650 mechanically coupled to switching liquid 130 to change the switching state of the switch.

Cavity 620 is composed of a switching portion 622, an actuating portion 624 and coupling portions 626 and 628. Actuating portion 624 is substantially parallel to switching cavity 622 and is offset from switching cavity 622 in the y-direction. Coupling portions 626 and 628 extend from opposite ends of actuating portion 624 to switching portion 622 and join switching portion 622 at points offset from one another along the length of the switching portion.

Switching liquid 130 occupies most of switching portion 622 of cavity 620. Actuating liquid 152 occupies actuating portion 624, part of coupling portion 626 and part of coupling portion 628. Insulating fluid 154 occupies the remainder of coupling portion 626 and, in the switching state shown in FIG. 10A, the remainder of switching portion 622. Insulating fluid 654 occupies the remainder of coupling portion 628.

Switch contacts 140, 141 and 142 are located in and extend from switching portion 622 of cavity 620. Switch contacts 140, 141 and 142 are arrayed in the x-direction along the length of switching portion 622 and are interleaved with coupling portions 626 and 628. Switch contact 141 is located between coupling portions 626 and 628, switch contact 140 is located in switching portion 622 on the opposite side of coupling portion 626 from switch contact 141 and switch contact 142 is located in switching portion 622 on the opposite side of coupling portion 628 from switch contact 141.

Lorentz actuator 650 is composed of conducting actuating liquid 152 located in the actuating portion 624 of cavity 620, opposed control electrodes 160 and 162 located in and extending from actuating portion 624 in electrical contact with actuating liquid 152 and a magnet 170 located adjacent actuating portion 624. Actuating portion 624, control electrodes 160 and 162, and magnet 170 are arranged such that the direction of current flow through actuating liquid 152 between control electrodes 160 and 162, the direction of the magnetic field applied by magnet 170 to actuating liquid 152 and the resulting direction of motion of actuating liquid 152 in actuating portion 624 are mutually orthogonal.

In the switching state of switch 600 shown in FIG. 10A, insulating fluid 154 occupies part of switching portion 622 of cavity 620 in addition to part of coupling portion 626. The portion of insulating fluid 154 occupying part of switching portion 622 divides switching liquid 130 into a switching liquid portion 632 in electrical contact only with switch contact 140 and a switching liquid 634 portion in electrical contact with switch contacts 141 and 142. Thus, switching liquid portion 634 electrically connects switch contacts 141 and 142, but insulating fluid 154 electrically insulates switch contact 140 from the other two switch contacts.

FIG. 10B shows the switching state of switch 600 after a control voltage has been applied between control electrode 160 and control electrode 162. The motive force generated by the interaction of the resulting control current passing through actuating liquid 152 and the magnetic field generated by magnet 170 moves actuating liquid 152 in the +x-direction. The movement of actuating liquid 152 in the +x-direction drives insulating fluid 654 through the coupling portion 628 of cavity 620 into switching portion 622, where insulating fluid 654 divides switching liquid portion 634 into switching liquid portion 636 that remains in electrical contact only with switch contact 142 and a switching liquid portion that moves in the −x-direction in the switching portion 622 of cavity 620. The moving switching liquid portion expels insulating fluid 154 from the switching portion, which allows the moving switching liquid portion to join with switching liquid portion 632 to form switching liquid portion 638. Switching liquid portion 638 is in electrical contact with switch contacts 140 and 141. Thus, switching liquid portion 638 electrically connects switch contacts 140 and 141, but insulating fluid 654 electrically isolates switch contact 142 from the other two switch contacts.

To restore switch 600 to the switching state shown in FIG. 10A, a control voltage is applied between control electrode 162 and control electrode 160. The motive force generated by the interaction of the resulting control current passing through actuating liquid 152 and the magnetic field generated by magnet 170 moves actuating liquid 152 in the −x-direction. The movement of actuating liquid 152 in the −x-direction drives insulating fluid 154 through the coupling portion 626 of cavity 620 into switching portion 622, where insulating fluid 154 divides switching liquid portion 638 into switching liquid portion 632 that remains in electrical contact only with switch contact 142, as described above, and a switching liquid portion that moves in the +x-direction in the switching portion 622 of cavity 620. The moving switching liquid portion expels insulating fluid 654 from the switching portion, which allows the moving switching liquid portion to join with switching liquid 636 to re-form switching liquid portion 634, described above.

In a double-pole version (not shown) of switch 600, cavity 620 has an additional switching portion with switch contacts arrayed along its length in an arrangement similar to that of switching portion 622 described above. The switch contacts are interleaved with two additional coupling portions that extend to the opposite ends of actuating portion 624.

The switching states of the above-described metallic contact switch embodiments are metastable. Referring to FIGS. 2A-2C, for example, when the control current stops flowing between the control electrodes 160 and 162 of Lorentz actuator 150, moving element 158, composed of switching liquid 130, insulating fluid 154 and actuating liquid 152, stops moving in cavity 120 and remains in the position to which it has moved until a control current flows once again. However, an external stimulus, such as a mechanical shock or vibration, can cause moving element 158 to move in the cavity. Sufficient movement of the moving element can result in an undesired change the switching state of the switch.

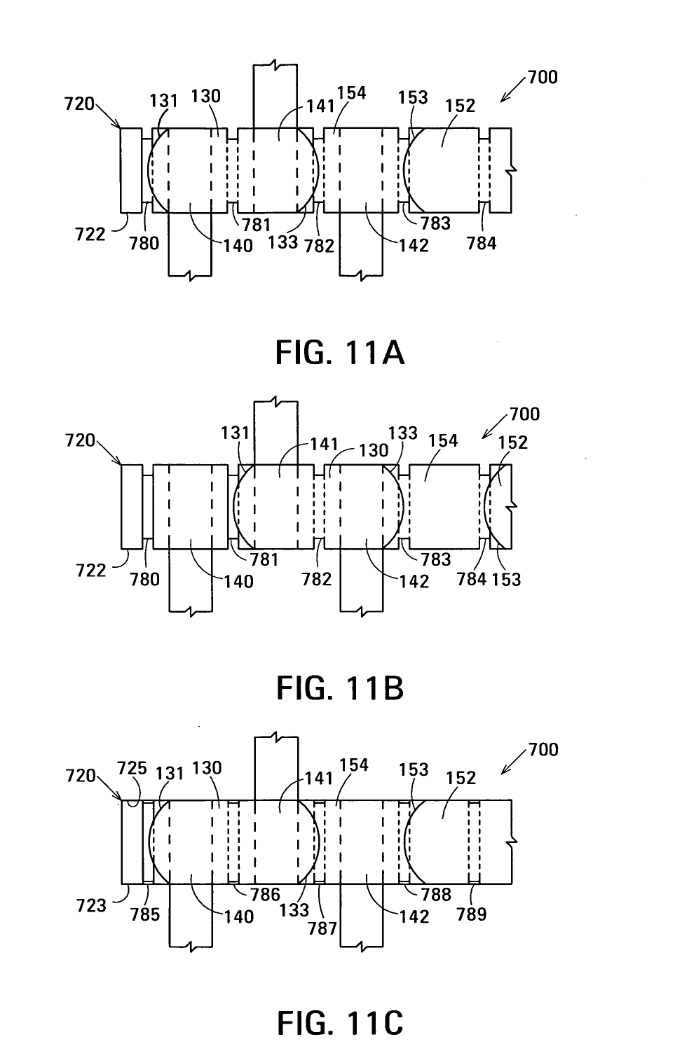

FIGS. 11A and 11B are enlarged cut-away plan views showing part of a seventh embodiment 700 of a switch in which the structure of the cavity is modified to increase the stability of the switching states of the switch. The modified structure of the cavity reduces the ability of an external stimulus, such as a mechanical shock or vibration, to move the moving element in the cavity and, hence, to change the switching state of the switch. The modified cavity structure will be described with reference to the cavity of a single-pole, double-throw switch similar to that shown in FIGS. 5A and 5B. The cavities of the other embodiments of the switch described herein may be similarly modified. Elements of the switch shown in FIGS. 11A and 11B that correspond to elements of the switches described above are indicated using the same reference numerals and will not be described again in detail.

FIGS. 11A and 11B show the switching portion 722 of the cavity 720 of switch 700. The remainder of switch 700 is not shown to simplify the drawing, but is similar to switch 200 described above with reference to FIGS. 5A and 5B. Switch contacts 140, 141 and 142 are located in and extend from the switching portion 722 of cavity 720. Switch contacts 140, 141 and 142 are arrayed in the x-direction along the length of switching portion 722 in a manner similar to that described above. Only the parts of switch contacts 140, 141 and 142 in and immediately adjacent switching portion 722 are shown to simplify the drawing.

Switching portion 722 has constrictions 780, 781, 782 and 783 arrayed in the x-direction along its length. Constrictions 780-783 are interleaved with switch contacts 140-142. In each of constrictions 780-783, the cross-sectional area of switching portion 722 is less than that of the remainder of switching portion 722, e.g., less than that of the part of switching portion in which switch contact 140 is located. Constrictions 780 and 782 are separated in the x-direction and constrictions 781 and 783 are separated in the x-direction by respective distances approximately equal to, but not less than, the length of switching liquid 130 in switching portion 722.

In the switching state shown in FIG. 11A, the moving element composed of switching liquid 130, insulating fluid 154 and actuating liquid 152 is free to move over a short distance in both the +x- and −x-directions. Electrical contact between switching liquid 130 and switch electrodes 140 and 141 is maintained over this range of movement. However, as the moving element moves further in the −x-direction, before switching liquid 130 loses contact with switch contact 141, the end surface 131 of switching liquid 130 encounters constriction 780. The encounter decreases the radius of curvature of end surface 131, which generates a force in the +x-direction. The force resists further motion of the moving element in the −x-direction, and helps maintain contact between switching liquid 130 and switch contact 141. Additionally, the end surface 153 of actuating liquid 152 encountering constriction 783 generates a force with a component in the +x-direction that additionally resists movement of the moving element in the −x-direction.

As the moving element moves in the +x-direction, before switching liquid 130 loses contact with switch contact 140, the end surface 133 of switching liquid 130 encounters constriction 782. The resulting decrease in the radius of curvature of end surface 133 generates a force in the −x-direction. The force resists further motion of the moving element in the +x-direction, and helps maintain contact between switching liquid 130 and switch contact 140.

FIG. 11B shows switch 700 in its other switching state. The Lorentz actuator (not shown) of switch 700 generates a substantially greater motive force in the x-direction than the Lorentz actuator of switch 200 described above with reference to FIGS. 5A and 5B. The additional motive force is needed to drive the end surface 133 of switching liquid 130 through constriction 782 and to drive the end surface 131 of the switching liquid through constriction 781. Once switch 700 is in its switching state shown in FIG. 11B, interaction between the end surface 131 of switching liquid 130 and constriction 781 resists motion of the moving element in the +x-direction and helps maintain contact between the switching liquid and switch contact 141. Moreover, interaction between the end surface 133 of switching liquid 130 and constriction 783 resists motion of the moving element in the −x-direction and helps maintain contact between the switching liquid and switch contact 142.

Also shown in FIGS. 11A and 11B is an optional constriction 784 in switching portion 722. Constriction 784 is offset in the +x-direction relative to adjacent constriction 783. Interaction between the end surface 153 of actuating liquid 152 and constriction 784 resists further motion of the actuating liquid in the −x-direction, and, hence, helps maintain contact between switching liquid 130 and switch contact 142 in the switching state shown in FIG. 11B.

Additional constrictions (not shown) may be located in the actuating portion (not shown) of cavity 720 to control the positioning of actuating liquid 152 in the actuating portion. Moreover, in embodiments with more than one switching portion, additional constrictions may be located in each switching portion.

FIG. 11C is an enlarged cut-away plan view showing an alternative switching portion 723 of the cavity 720 of switch 700 that increases the stability of the switching states of the switch. Alternative switching portion 723 reduces the ability of an external stimulus, such as a mechanical shock or vibration, to move the moving element lengthways in the cavity and, hence, to change the switching state of the switch. The alternative switching portion will be described with reference to the cavity of a single-pole, double-throw switch similar to that shown in FIGS. 5A and 5B. The cavities of the other embodiments of the switch described herein may be similarly modified.

Switching portion 723 has an internal wall comprising alternate regions having a low wettability and a high wettability with respect to switching liquid 130. In this disclosure, the terms high wettability and low wettability are used in a relative rather than an absolute sense. Thus, a material having a low wettability with respect to the switching liquid has a lower wettability with respect to the switching liquid and a material having a high wettability with respect to the switching liquid, and a material having a high wettability with respect to the switching liquid has a higher wettability with respect to the switching liquid and a material having a low wettability with respect to the switching liquid. In the example shown, switching portion 723 is defined in second substrate 114 (FIG. 2A, for example) with its internal wall 725 of a material having a high wettability with respect to switching liquid 130. Arrayed along switching portion 723 are bands 785, 786, 787 and 788 of a material having a low wettability with respect to switching liquid 130. Bands 785-788 are interleaved with switch contacts 140-142. Bands 785 and 787 are separated in the x-direction and bands 786 and 788 are separated in the x-direction by a distance approximately equal to, but not less than, the length of switching liquid 130 in switching portion 723.

In an embodiment in which switching liquid 130 is mercury, metals have a high wettability with respect to mercury and typical substrate materials have a low wettability with respect to mercury. However many metals form amalgams with mercury. In an exemplary embodiment, the material of second substrate 114 has a low wettability with respect to mercury, and the wall 725 of the switching portion 722 of cavity 720 outside bands 785, 786, 787 and 788 is coated with a high wettability material, and the substrate material is exposed in bands 785, 786, 787 and 788. In an exemplary embodiment, the wall outside bands 785, 786, 787 and 788 is coated with an adhesion layer of chromium (Cr) and a layer of a metal such as platinum (Pt) or iron (Fe) that is not dissolved by mercury to form an amalgam. In an alternative embodiment, the high-wettability material is rhodium (Rh). In embodiments in which the material of second substrate 114 has a relatively high wettability with respect to switching liquid 130, or in embodiments in which an especially high wettability contrast between the regions of low wettability and high wettability is desired, wall 725 is coated in bands 785, 786, 787 and 788 with a material having a low wettability with respect to the switching liquid. Glass and many plastics have a low wettability with respect to mercury.

In the switching state shown in FIG. 11C, the moving element composed of switching liquid 130, insulating fluid 154 and actuating liquid 152 is free to move over a short distance in both the +x- and −x-directions in contact with switch electrodes 140 and 141. Electrical contact between switching liquid 130 and switch electrodes 140 and 141 is maintained over this range of movement. The end surface 131 of switching liquid 130 is in contact with wall 725 of high wettability material and therefore has a relatively large radius of curvature. However, as the moving element moves further in the −x-direction, before switching liquid 130 loses contact with switch contact 141, the end surface 131 of switching liquid 130 encounters band 785 of low wettability material. The encounter decreases the radius of curvature of end surface 131, which generates a force in the +x-direction. This force resists further motion of the moving element in the −x-direction, and helps maintain contact between switching liquid 130 and switch contact 141.

As the moving element moves in the +x-direction, before switching liquid 130 loses contact with switch contact 140, the end surface 133 of switching liquid 130 encounters band 787 of low wettability material. The resulting decrease in the radius of curvature of end surface 133 generates a force in the −x-direction. The force resists further motion of the moving element in the +x-direction, and helps maintain contact between switching liquid 130 and switch contact 140.

In an embodiment in which band 788 additionally has a low wettability with respect to actuating liquid 152, the decrease in the radius of curvature of the end surface 153 of actuating liquid 152 resulting from end surface 153 encountering band 788 generates a force in the +x-direction that additionally resists movement of the moving element in the −x-direction in the switching state shown in FIG. 11C.

In the other switching state (not shown) of embodiment of switch 700 shown in FIG. 11C, interaction between the end surface 131 of switching liquid 130 and band 786 of low wettability material resists motion of switching liquid 130 in the +x-direction, and interaction between end surface 133 and band 788 resists motion of switching liquid 130 in the −x-direction.

Also shown in FIG. 11C is an optional band 789 of a material having a low wettability with respect to actuating liquid 152. Band 789 is located in the +x-direction relative to adjacent band 788. Interaction between the end surface 153 of actuating liquid 152 and band 789 resists motion of actuating liquid 152 in the −x-direction, and, hence, helps maintain contact between switching liquid 130 and switch contact 142 in the other switching state.

Additional bands (not shown) of low-wettability material may be located in the actuating portion (not shown) of cavity 720 to control the positioning of actuating liquid 152 in the actuating portion. Moreover, a combination of the bands of low-wettability material shown in FIG. 11C and the constrictions shown in FIGS. 11A and 11B may be used in combination to control the position of the moving element in the cavity.

As an alternative to defining alternate regions having a low wettability and a high wettability with respect to switching liquid 130 by means of bands 785-780 of low-wettability material applied to a substrate of high-wettability material as shown in FIG. 11C, the material of substrate 114 may have a low wettability with respect to switching liquid 130. In this case, the wall 725 of switching portion 723 is covered in regions corresponding to those between the bands 785-788 shown in FIG. 11C with bands of a material having a high wettability with respect to switching liquid 130. Such bands are shaped to expose switch contacts 140-142 to switching liquid 130.

The structures described above with reference to FIGS. 11A-11C also serve to define the positions in which switching liquid stops relative to switch contacts 140 and 141 and relative to switch contacts 141 and 142 when the switching state of switch 700 is changed.

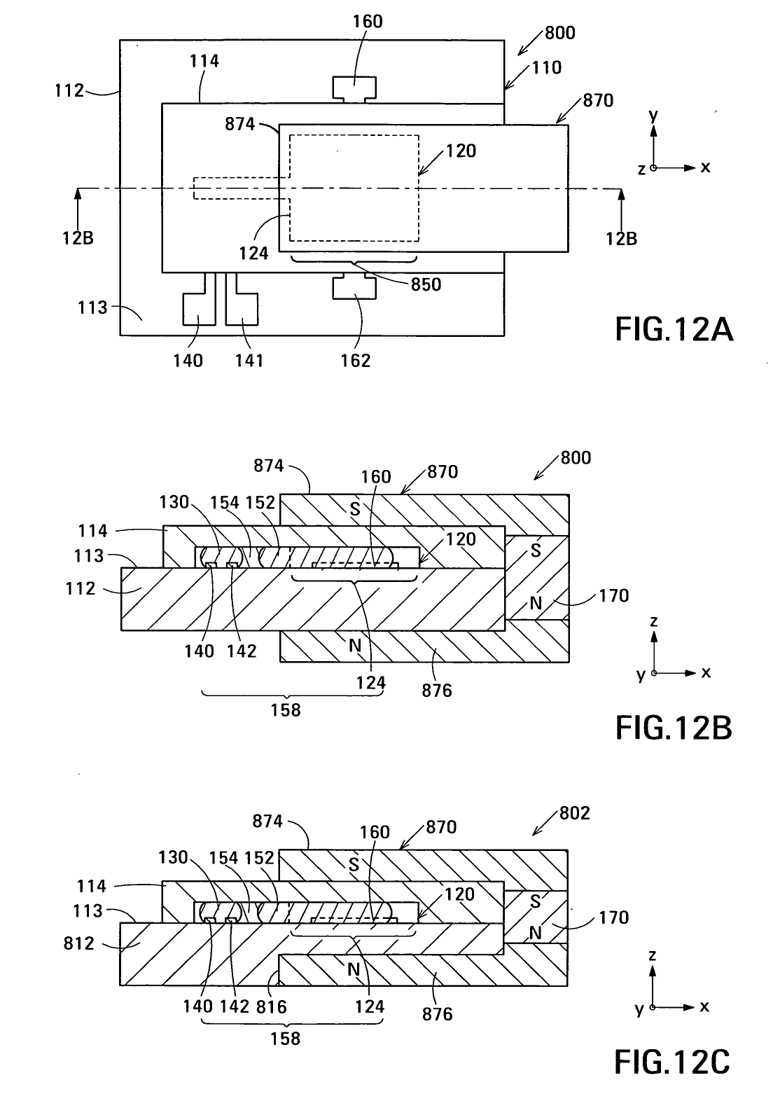

FIGS. 12A and 12B are respectively a plan view and a cross-sectional view of an eighth embodiment 800 of a metallic contact switch in accordance with the invention in which the magnitude of the control current needed for the Lorentz actuator to generate a given motive force is reduced. Switch 800 will be described with reference to a single-pole, single-throw switch similar to that described above with reference to FIGS. 2A-2B. Elements of switch 800 that correspond to elements of the switch described above with reference to FIGS. 2A-2C are indicated by the same reference numerals and will not be described again here. Lorentz actuators similar to those to be described next may be incorporated into the other embodiments of the switch described herein.

In the Lorentz actuator 850 of switch 800, a magnet assembly 870 incorporating magnet 170 applies the magnetic field to actuating liquid 152. For a given strength of magnet 170, magnet assembly 870 applies a substantially greater magnetic field to actuating liquid 152 than the arrangement described with reference to FIGS. 2A-2C in which the magnetic field is applied by magnet 170 affixed to second substrate 114 adjacent the actuating portion of the cavity.

Magnet assembly 870 is composed of magnet 170 and ferromagnetic pole pieces 874 and 876. Magnet 170 is located adjacent one side of housing 110 with its polar axis orthogonal to the major surface 113 of first substrate 112. Pole piece 874 extends across second substrate 114 from magnet 170 to the region of substrate 114 in which the actuation portion 124 of cavity 120 is defined. The locations of cavity 120, and, in particular, the actuation portion 124 thereof, relative to pole piece 874 are shown by broken lines in FIG. 12A.

Referring now to FIG. 12B, pole piece 876 extends across first substrate 112 from magnet 170 to the region of substrate 112 aligned with the actuation portion 124 of cavity 120 defined in substrate 114. The locations of cavity 120, and, in particular, the actuation portion 124 thereof, relative to pole pieces 874 and 876 are shown in FIG. 12B. In switch 800, actuating liquid 152 is located in the high-intensity magnetic field that exists in a gap in the magnetic circuit formed by magnet 170 and pole pieces 874 and 876.

FIG. 12C is a cross-sectional view showing a variation 802 on switching device 800 in which first substrate 812 defines a recess 816 that accommodates pole piece 876. Pole piece 876 extends from magnet 170 to the region of substrate 812 aligned with the actuation portion 124 of cavity 820 defined in second substrate 114. The location of cavity 120, and, in particular, actuation portion 124, relative to pole pieces 874 and 876 is shown in FIG. 12C. Locating pole piece 876 in recess 816 in first substrate 812 reduces the distance between pole pieces 874 and 876, which increases the strength of the magnetic field in the gap in the magnetic circuit in which actuating liquid 152 is located.

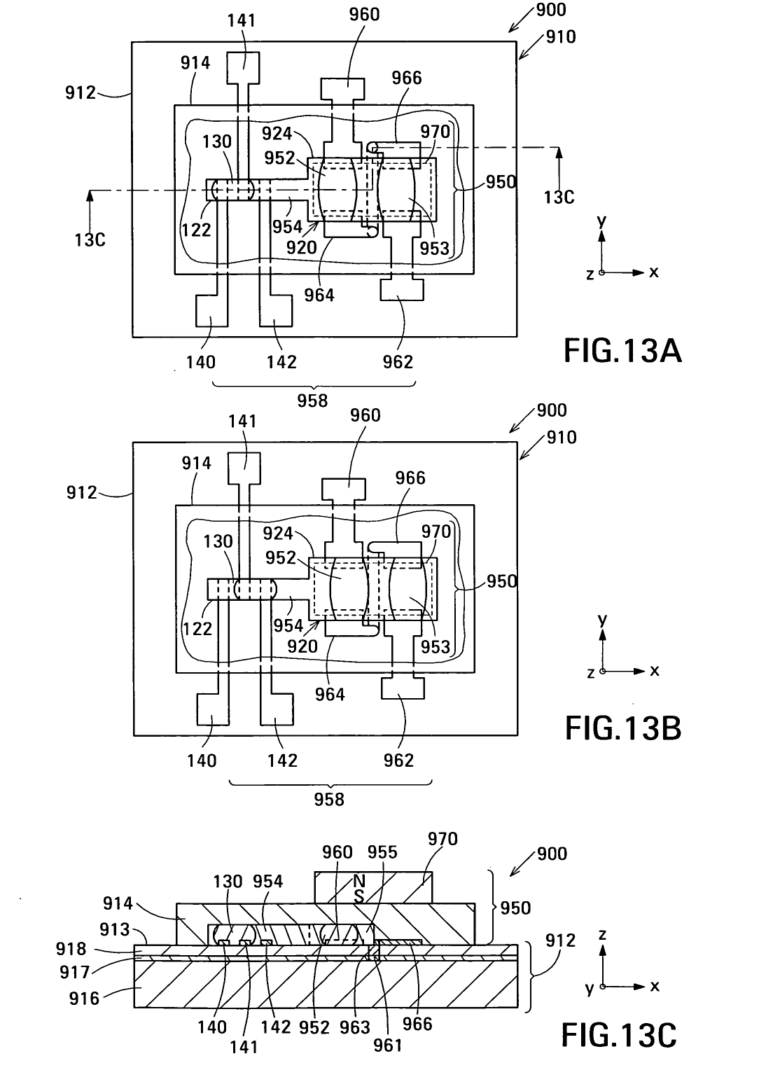

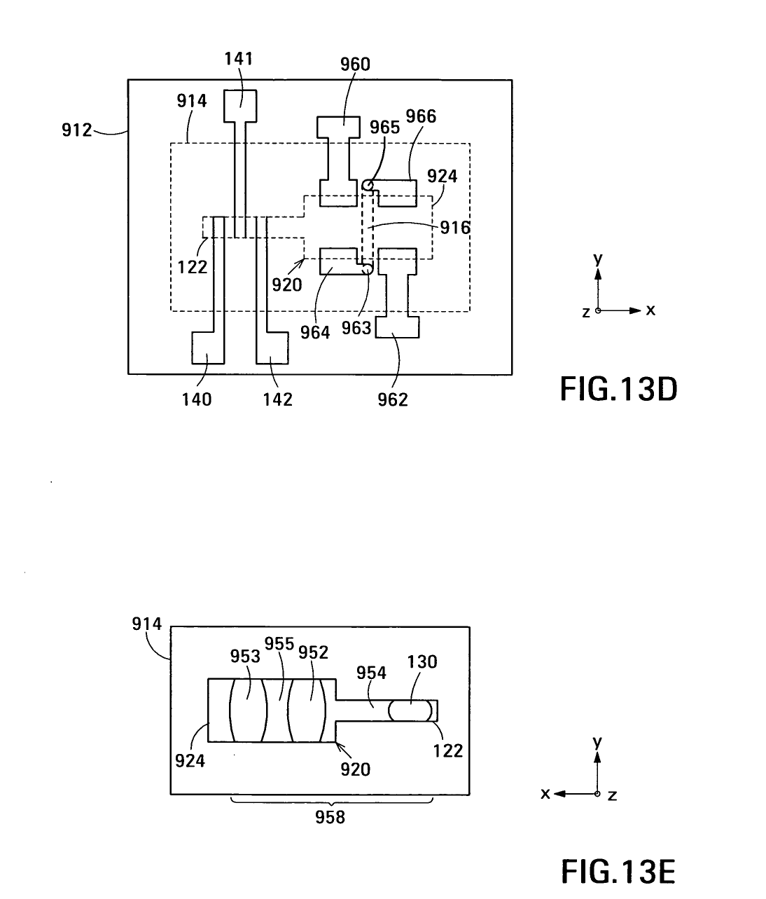

FIGS. 13A, 13B and 13C are respectively two cut-away plan views and a cross-sectional view of a ninth embodiment 900 of a metallic contact switch in accordance with the invention in which the magnitude of the control current needed for the Lorentz actuator to generate a given motive force is further reduced, and which the resistance of the Lorentz actuator is increased. FIGS. 13D and 13E are plan views of the first and second substrates, respectively, of switch 900. Switch 900 will be described with reference to a single-pole, double-throw switch similar to that shown in FIGS. 5A and 5B. Elements of switch 900 that correspond to elements of the switches described above are indicated by the same reference numerals and will not be described again here. Lorentz actuators similar to that to be described next may be incorporated into the other embodiments of the switch described herein.

In switch 900, cavity 920 is composed of a switching portion 122 and an actuating portion 924 in tandem in an arrangement similar to that described above. The length of actuating portion 924 is increased to accommodate part of insulating fluid 154, switching liquid 152, insulating fluid 954 and switching liquid 952 arranged in tandem in order in the x-direction. Additionally located in actuating portion 924 are opposed control electrodes 960 and 964 in electrical contact with switching liquid 152 and opposed control electrodes 966 and 962 in electrical contact with switching liquid 952. Control electrodes 960 and 962 extend from switching portion 924 to allow them to be connected to a control circuit (not shown). Control electrodes 964 and 966 are internally connected in series by a trace 961 (FIG. 13D) that extends across actuating portion 924 in the y-direction. Trace 961 is insulated from switching liquid portions 152 and 952 located in actuating portion 924. Alternatively, control electrodes 964 and 966 are similar in shape to control electrodes 960 and 962 and are externally connected in series.

Magnet 970 is shaped to apply a magnetic field to actuating liquid 152 and actuating liquid 952 over their full range of travel in the actuating portion 924 of cavity 920. Alternatively, separate magnets may be used to apply respective magnetic fields to switching liquid 152 and switching liquid 952. As a further alternative, an arrangement of pole pieces similar to that described above with reference to FIGS. 12A-12C may be used to apply a magnetic field to actuating liquid 152 and actuating liquid 952 collectively or individually.

Insulating fluid 954 mechanically couples the motive force generated by passing a control current through switching liquid 952 to the motive force generated by additionally passing the control current through switching liquid 152. Thus, each of the actuating liquids 152 and 952 need generate only one-half of the motive force that Lorentz actuator 950 is required to generate to move moving element 958, composed of switching liquid 130, insulating fluid 154, actuating liquid 152, insulating fluid 954 and actuating liquid 952, in the +x- or −x-direction. The additional mass of insulating fluid 954 and actuating liquid 952 is less than that of switching liquid 130, insulating fluid 154 and actuating liquid 152, so that the control current through each of actuating liquid 152 and actuating liquid 952 is less than of a Lorentz actuator such as that shown in FIGS. 2A-2C having a single portion of actuating liquid. Control electrodes 964 and 966 are connected in series, so that a control voltage applied between control electrodes 960 and 962 or vice versa causes the same control current to pass through both actuating liquid 152 and actuating liquid 952.

Lorentz actuators have a low electrical resistance: electrically connecting two Lorentz actuators in series as just described provides a Lorentz actuator with an increased electrical resistance that has a better impedance match with a typical control circuit.

The cross-sectional view of FIG. 13C shows details of the internal series connection between electrodes 964 and 966 (FIG. 13A). First substrate 913 is composed of a base 916 having electrically-conducting trace 961 located on its major surface. The remainder of the major surface of the base is covered by a planarizing layer 917. A layer 918 of an electrically-insulating material covers the planarizing layer and the trace. Switch contacts 140-142 and control electrodes 960, 962, 964 and 966 are located on the major surface of insulating layer 918. Referring additionally to FIG. 13D, apertures in insulating layer 918 at both ends of trace 961 accommodate vias 963 and 965 electrically connected to the trace. Control electrode 964 is electrically connected to the end of via 963 remote from trace 961. Control electrode 966 is electrically connected to the end of via 966 remote from trace 961. Thus, vias 963 and 965 and trace 961 form an circuit that electrically connects control electrode 964 to control electrode 966.

In the example shown in FIGS. 13A-13C, two portions of actuating liquid and respective pairs of opposed control electrodes are located in actuating portion 924. In other embodiments, the number of portions of actuating liquid and respective opposed electrodes located in actuating portion 924 is greater than two. Additional traces, similar to trace 961, are provided to connect the electrodes contacting the portions of actuating liquid in series. Moreover, in further embodiments, the travel of the moving element of the Lorentz actuator is defined in a manner similar to that described above with reference to FIG. 7B. In such embodiments, two pair of opposed electrodes, are located to make contact with each portion of actuating liquid in actuating portion 924. The electrodes for imparting forward motion and those for imparting reverse motion are separately connected in series. In embodiments in which the series connections are internal, traces similar to trace 961 are provided at different levels in substrate 912 to provide the forward and reverse interconnections, respectively.

Fabrication of an embodiment of a switch in accordance with the invention will be described next with reference to an exemplary fabrication of switch 100 described above with reference to FIGS. 2A-2C, 3A, 3B, 4A and 4B. Fabrication of the other embodiments described herein is similar.

Although embodiments of a metallic contact switch in accordance with the invention can be individually fabricated, the switches are typically fabricated by wafer-scale processing in which wafers containing the respective substrates of hundreds or thousands of switches are processed and assembled. The assembled wafers are then singulated into individual switches or are divided into small arrays of switches.

Switch 100 is fabricated as follows. Referring first to FIG. 4A, a first wafer of which first substrate 112 forms part is provided. Examples of suitable materials for the first wafer are silicon, glass, ceramic and plastic. A metal substrate with an insulating layer on its major surface may alternatively be used. The switch contacts 140 and 141 and the control electrodes 160 and 162 of each switch are defined in a conducting material on one major surface of the first wafer. In an embodiment, a conducting layer, such as a layer of Pt or Fe, is deposited on the major surface of the wafer of which substrate 112 forms part. The conducting layer is patterned by etching or a lift-off process to define switch contacts 140 and 141 and control electrodes 160 and 162. In other embodiments, the switch contacts and control electrodes are deposited on the major surface of the wafer by such processes as screen printing and lamination. In some embodiments, the switch contacts and the control electrodes are of different materials.

In some embodiments, either or both of the switch contacts 140 and 141 and the control electrodes 160 and 162 are composed of layers of more than one material. In an example, the switch contacts and control electrodes are composed of a thin adhesion layer, a thick conduction layer of a high-conductivity material, and a thin contact layer of a material having a relatively high wettability with respect to switching liquid 130 and actuating liquid 152. Additionally, the material of the contact layer is one that is insoluble in, and is not otherwise eroded by, the switching liquid and the actuating liquid. For example, the material of the adhesion layer is titanium, the material of the conduction layer is gold and the material of the contact layer is rhodium. In another example, the adhesion layer is chromium and a combined conduction layer and contact layer is platinum, rhodium or iron.

The first wafer may optionally be subject to processing similar to that to be described below to define at least part of cavity 120 therein.

Referring now to FIG. 4B, a second wafer of which second substrate 114 forms part is provided. Examples of suitable materials for the second wafer are silicon, glass, ceramic and plastic. The second wafer is processed to define the shapes of the individual second substrates. The second substrates are shaped to expose the bonding pads that form part of the switch contacts and control electrodes in the assembled switch. Exemplary processes that can be used to define the shapes of the individual second substrates are selective etching or selective ablation applied to a silicon, glass or fired ceramic second wafer, and molding applied to a green ceramic or plastic second wafer. Prior to the shape-defining processing, the second wafer may be attached to a handle wafer to maintain its structural integrity during subsequent processing.

As part of the shape-defining processing or separately, the cavity 120 of each switching device 100 is defined in the second wafer. Processes similar to those described above for shape defining or other processes may be used. In embodiments, in which cavity 120 is wholly defined in first substrate 112, the processing of the second wafer to define cavity 120 is omitted.

The second wafer of which second substrate 114 forms part is oriented with the major surface 115 of substrate 114 facing up. A measured quantity of switching liquid 130 is placed in the switching portion 122 of the cavity 120 of each second substrate and a measured portion of actuating liquid 152 is placed in the actuating portion 124 of the cavity of each second substrate. In embodiments in which the insulating fluid is a liquid, a measured quantity of insulating fluid 154 is placed in the cavity 120 of each second substrate between the switching liquid and the actuating liquid. Techniques for dispensing measured quantities of liquid metals are described by Fazzio in U.S. patent application Ser. No. 10/826,249, filed on 16 Apr. 2004, entitled Liquid Metal Processing and Dispensing for Liquid Metal Devices, assigned to the assignee of this disclosure and incorporated herein by reference. Materials useable as the switching liquid and the actuating liquid include mercury (Hg), gallium (Ga), an alloy comprising gallium and indium, an alloy comprising gallium, indium and tin, and a slurry of conducting particles in a carrier liquid. Materials useable as the insulating fluid include a gas, an inert gas, nitrogen (N₂), argon (Ar), a liquid, a low-viscosity liquid, methanol (CH₃OH), ethanol (C₂H₅OH) and a transformer oil.

The major surface of the second wafer of which second substrate 114 forms part is coated with a thin layer of a bonding material, such as an adhesive. The first wafer of which substrate 112 forms part is then inverted and is placed on the second wafer in the appropriate alignment. The first and second wafers typically carry reference marks to ensure the accuracy of the alignment between the wafers. The bonding material is then cured to bond the wafers together. The assembled wafers are then singulated into individual switches. The switches may be tested prior to singulation.

In some embodiments, the first wafer of which first substrate 112 forms part is attached to the second wafer of which second substrate 114 forms part in vacuo, or at least under reduced pressure, to avoid Lorentz actuator 150 having to compress air trapped at the end of the switching portion 122 of cavity 120 remote from actuating portion 124 and at the end of actuating portion 124 remote from switching portion 122 during operation of switch 100. In embodiments in which insulating fluid 154 is a gas, the first wafer is attached to the second wafer in an atmosphere of the insulating fluid. In such embodiments, insulating fluid is additionally located at the remote ends of switching portion 122 and actuating portion 124 of cavity 120, and cavity 120 typically incorporates a pressure equalizing portion 126 as shown in FIG. 4B.

This disclosure describes the invention in detail using illustrative embodiments. However, the invention defined by the appended claims is not limited to the precise embodiments described.

We claim:

1. A metallic contact switch, comprising:
a housing defining a cavity;
conducting switching liquid in the cavity;
switch contacts located in the cavity in electrical contact with the switching liquid in at least one switching state of the switch; and
a Lorentz actuator comprising conducting actuating liquid located in the cavity and capable of movement therein, the Lorentz actuator mechanically coupled to the switching liquid to change the switching state of the switch.

2. The switch of claim 1, in which the actuating liquid comprises one of mercury (Hg), gallium (Ga), an alloy comprising gallium and indium, an alloy comprising gallium, indium and tin, and a slurry comprising conducting particles and a liquid carrier.

3. The switch of claim 1, additionally comprising insulating fluid located in the cavity between the switching liquid to the actuating liquid.

4. The switch of claim 3, in which the insulating fluid comprises one of a gas, an inert gas, nitrogen (N₂), argon (Ar), a liquid, a low-viscosity liquid, methanol (CH₃OH) and ethanol (C₂H₅OH).

5. The switch of claim 1, in which a single body of conducting liquid constitutes the switching liquid and the actuating liquid.

6. The switch of claim 1, in which:
the actuating liquid is capable of movement in the cavity in a first direction; and
the Lorentz actuator additionally comprises:
opposed control electrodes located in the cavity in electrical contact with the actuating liquid in at least one switching state of the switch, and means for applying a magnetic field across the actuating liquid.

7. The switch of claim 6, in which:
the control electrodes are opposed in a second direction;
the means for applying applies the magnetic field to the actuating liquid in a third direction; and
the first, second and third directions are mutually orthogonal.

8. The switch of claim 6, in which the control electrodes comprise a pair of control electrodes opposite a single control electrode.

9. The switch of claim 6, in which the control electrodes comprise a first pair of control electrodes opposite a second pair of control electrodes.

10. The switch of claim 6, in which the means for applying comprises a permanent magnet.

11. The switch of claim 10, in which:
the means for applying additionally comprises pole pieces magnetically coupled to the permanent magnet; and
the actuating liquid is located between the pole pieces.

12. The switch of claim 1, in which:
the Lorentz actuator additionally comprises opposed control electrodes located in the cavity in electrical contact with the actuating liquid in at least one switching state of the switch; and
the cavity comprises:
an actuating portion in which the control electrodes are located;
a switching portion in which the switch contacts are located; and
coupling portions extending from opposite ends of the actuating portion to junctions with the switching portion, the junctions separated from one another along the length of the switching portion.

13. The switch of claim 12, in which the junctions are interleaved with the switch contacts.

14. The switch of claim 1, in which:
the Lorentz actuator additionally comprises opposed control electrodes located in the cavity in electrical contact with the actuating liquid in at least one switching state of the switch; and
the cavity comprises an actuating portion in which the control electrodes are located and a switching portion in which the switch contacts are located; and
the actuating portion is greater in cross-sectional area than in the switching portion.

15. The switch of claim 1, in which the housing comprises:
a first substrate having a plane major surface on which the switch contacts and the control electrodes are located; and
attached to the first substrate, a second substrate in which the cavity is defined at least in part.

16. The switch of claim 15, in which the cavity is toroidal in shape.

17. The switch of claim 1, in which the cavity is toroidal in shape.

18. The switch of claim 17, in which:
the switching liquid comprises switching liquid portions; and
the switch additionally comprises portions of insulating fluid separating the switching liquid portions from one another and from the actuating liquid.

19. The switch of claim 1, in which:
the switching liquid comprises switching liquid portions; and
the switch additionally comprises portions of insulating fluid separating the switching liquid portions from one another and from the actuating liquid.

20. The switch of claim 1, in which the cavity comprises alternate regions of materials having differing wettabilities with respect to the switching liquid, the regions arrayed in the first direction:

21. The switch of claim 1, in which the cavity comprises constrictions arrayed in the first direction.

22. The switch of claim 1, in which:
the actuating liquid comprises actuating liquid portions interleaved with insulating fluid portions, the actuating liquid portions and the insulating fluids arranged in tandem in the first direction in the cavity; and
in electrical contact with each of the actuating liquid portions, a pair of opposed control electrodes.

23. The switch of claim 22, in which the Lorenz actuator additionally comprises a series electrical connection, independent of the actuating liquid portions, between one of the pair of control electrodes of one of the actuating liquid portions and the other of the pair of the control electrodes of another of the actuating liquid portions.
